(19) United States
(12) Patent Application Publication
(10) Pub. No.: US 2014/0161011 A1
(43) Pub. Date: Jun. 12, 2014

(54) COMMUNICATION APPARATUS, COMMUNICATION METHOD, AND COMPUTER PRODUCT

(71) Applicant: FUJITSU LIMITED, Kawasaki-shi (JP)

(72) Inventors: Yasushi Hara, Yokohama (JP); Katsumi Otsuka, Kawasaki (JP); Ryosuke OISHI, Kunitachi (JP)

(73) Assignee: FUJITSU LIMITED, Kawasaki-shi (JP)

(21) Appl. No.: 14/179,080

(22) Filed: Feb. 12, 2014

Related U.S. Application Data
(63) Continuation of application No. PCT/JP2011/068712, filed on Aug. 18, 2011.

(51) Int. Cl. H04W 52/02; H04L 29/12

(52) U.S. Cl. CPC H04W 52/0209; H04L 61/2007
USPC 370/311

(57) ABSTRACT

A communication apparatus includes a processor configured to access a server that assigns to the communication apparatus, identification information used to identify the communication apparatus in a network; and control to suspend an accessing of the server when a display state of a screen transitions from a displaying state to a not-displaying state, such that the accessing of the server is restarted when the display state of the screen transitions from the not-displaying state to the displaying state.

### CROSS REFERENCE TO RELATED APPLICATIONS

This application is a continuation application of International Application PCT/JP2011/068712, filed on Aug. 18, 2011 and designating the U.S., the entire contents of which are incorporated herein by reference.

### FIELD

The embodiments described herein are related to a communication apparatus, a communication method, and a computer product.

### BACKGROUND

When a portable terminal establishes connection to an Internet protocol (IP) network through a mobile communication network, for example, an IP address is assigned to the portable terminal from a server of a communication common carrier. In this case, address resources are limited and, to prevent depletion of the address resources, the server of the communication common carrier releases the IP address assigned to a portable terminal that does not access the server for a given time period (for example, 30 min).

On the other hand, when the IP address assigned to the portable terminal is released, the portable terminal may be unable to receive any service. Therefore, one type of portable terminal has a function incorporated therein of enabling the portable terminal to continuously retain the IP address by accessing the server at predetermined cycles (for example, 28-min cycles) (known as an “always-on function”).

According to related technique, for example, when a time period to continuously stand by for a call or a time period without continuously executing any operation exceeds a predetermined time period, supply of the electric power from a battery to a backlight is refused and thereby, the light emission thereof is suspended. Another technique is present for an information processing apparatus connected to a network through an interfacing apparatus and capable of communicating with a server, to periodically transmit to the server, information concerning the information processing apparatus. When this information processing apparatus causes its state to transition from a normal state to an electric-power saving state, the information processing apparatus causes the periodical transmission to continue by notifying the interfacing apparatus of address information of the server and information concerning the information processing apparatus.

Another technique is present as a technique to suppress any increase of the surface temperature of a housing of a mobile telephone. According to which the technique, when a detected temperature value of the device or that around the device exceeds a threshold value after driving a camera, any intermittent driving or any continuous driving of the camera is temporarily suspended. A technique is present to reduce the power consumption of device apparatuses that are not engaged in any transmission and any reception of data in a communication system that executes the transmission and reception of data between a host apparatus and plural device apparatuses when transmission sessions and reception sessions of data are sequentially executed between the host apparatus and a specific device apparatus (see, e.g., Japanese Laid-Open Patent Publication Nos. 2004-320107, 2010-244464, 2007-312139, and 2006-186627).

However, according to the conventional techniques, a problem arises in that periodic access of the server that continuously retains the address (for example, the IP address) assigned to the portable terminal increases and thereby, the power consumption of the portable terminal increases.

### SUMMARY

According to an aspect of an embodiment, a communication apparatus includes a processor configured to access a server that assigns to the communication apparatus, identification information used to identify the communication apparatus in a network; and control to suspend an accessing of the server when a display state of a screen transitions from a displaying state to a not-displaying state, such that the accessing of the server is restarted when the display state of the screen transitions from the not-displaying state to the displaying state.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one example of a communication method according to a first embodiment;

FIGS. 2A and 2B are explanatory diagrams of an example of operation of a communication apparatus 101;

FIG. 3 is an explanatory diagram of an example of a system configuration of a communication system 300 according to the first embodiment;

FIG. 4 is a block diagram of an example of a hardware configuration of the communication apparatus 101 according to the first embodiment;

FIG. 5 is a block diagram of a hardware configuration example of a server 102, etc. according to the first embodiment;

FIG. 6 is an explanatory diagram of an example of the contents of an APN list;

FIG. 7 is a block diagram of an example of a functional configuration of the communication apparatus 101 according to the first embodiment;

FIG. 8 is a flowchart of an example of a procedure (Part I) for a communication process of the communication apparatus 101 according to the first embodiment;

FIG. 9 is a flowchart of an example of a procedure (Part II) for the communication process of the communication apparatus 101 according to the first embodiment;

FIG. 10 is a flowchart of an example of a procedure for a search process of the communication apparatus 101 according to the first embodiment;

FIG. 11 is a block diagram of an example of a functional configuration of the communication apparatus 101 according to a second embodiment;

FIGS. 12A and 12B are explanatory diagrams of an example of the communication method according to the second embodiment;

FIG. 13 is a flowchart of an example of a procedure for the communication process of the communication apparatus 101 according to the second embodiment;

FIG. 14 is a flowchart of an example of a specific process procedure for a service request process;

FIG. 15 is a block diagram of an example of a functional configuration of the communication apparatus 101 according to a third embodiment;

FIG. 16 is an explanatory diagram of an example of the contents of a APN deletion time period table 1600;

FIG. 17 is an explanatory diagram of an example of the communication method according to the third embodiment;

FIG. 18 is a flowchart of an example of a procedure for the communication process of the communication apparatus 101 according to the third embodiment;

FIG. 19 is a flowchart of an example of a specific process procedure for an updating process;

FIG. 20 is a block diagram of an example of a functional configuration of the communication apparatus 101 according to a fourth embodiment;

FIGS. 21A and 21B are explanatory diagrams of an example of the communication method according to the fourth embodiment;

FIG. 22 is a flowchart of an example of a procedure for a periodic communication process of the communication apparatus 101 according to the fourth embodiment;

FIG. 23 is a flowchart of an example of a procedure for the communication process of the communication apparatus 101 according to the fourth embodiment;

FIG. 24 is an explanatory diagram of an example of the contents of a by-app APN deletion time period table 2400;

FIG. 25 is an explanatory diagram of an example of the contents of a app startup time table 2500;

FIG. 26 is a block diagram of an example of a functional configuration of the communication apparatus 101 according to a fifth embodiment;

FIGS. 27A and 27B are explanatory diagrams of an example of the communication method according to the fifth embodiment;

FIG. 28 is a flowchart of an example of a procedure for an app management process of the communication apparatus 101 according to the fifth embodiment;

FIG. 29 is a flowchart of an example of a procedure for the communication process of the communication apparatus 101 according to the fifth embodiment;

FIG. 30 is a block diagram of an example of a functional configuration of the communication apparatus 101 according to a sixth embodiment;

FIG. 31 is an explanatory diagram of an example of the contents of a suspension time slot table 3100;

FIG. 32 is a flowchart (Part I) of an example of a procedure for the communication process of the communication apparatus 101 according to the sixth embodiment;

FIG. 33 is a flowchart (Part II) of the example of the procedure for the communication process of the communication apparatus 101 according to the sixth embodiment; and

FIG. 34 is a flowchart (Part III) of the example of the procedure for the communication process of the communication apparatus 101 according to the sixth embodiment.

### DESCRIPTION OF EMBODIMENTS

Embodiments of a communication apparatus, a communication method, and a computer product will be described in detail with reference to the accompanying drawings.

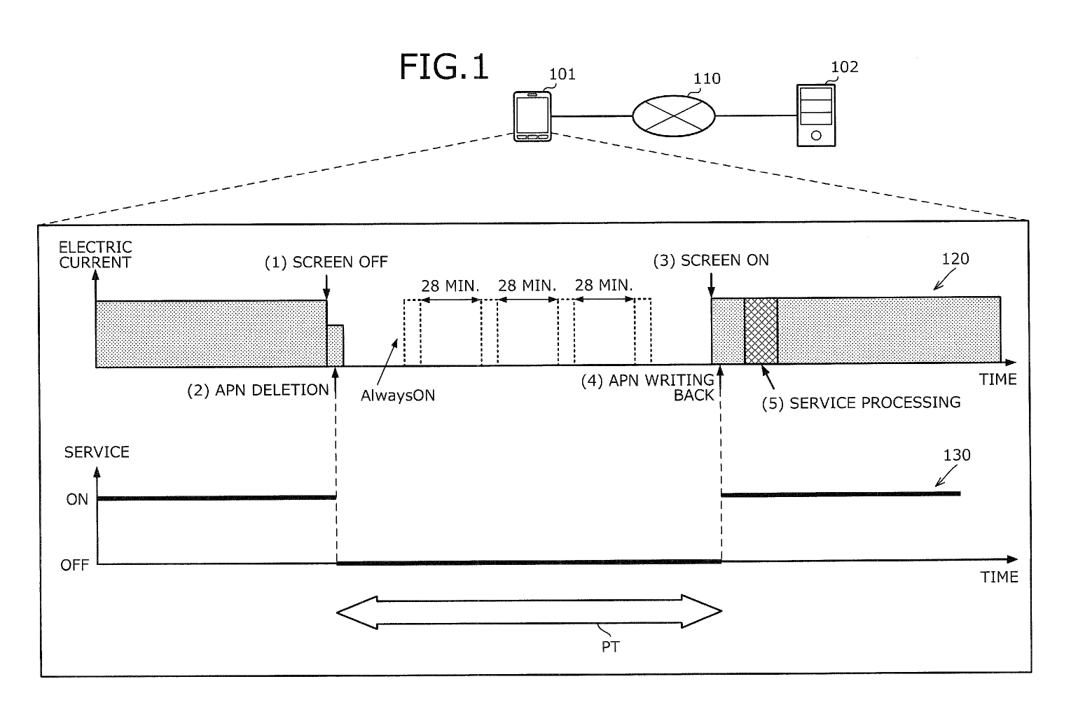

FIG. 1 is an explanatory diagram of one example of the communication method according to a first embodiment. In FIG. 1, a communication apparatus 101 is a computer capable of accessing a server 102 through a network 110, and is, for example, a smartphone, a tablet personal computer (PC), a mobile telephone, or a personal handy-phone system (PHS).

The server 102 is a computer supplying services to the communication apparatus 101. The “services” are each an information process supplied to the communication apparatus 101 and are, for example, an e-mail service, a calendar synchronization service, and a contact address synchronization service. The network 110 is, for example, a public wireless network and is, for example, a mobile communication network (mobile telephone network) that uses wired communication between base stations and wireless communication between a base station and a mobile station.

Identification information is assigned from the server 102 to the communication apparatus 101. The “identification information” is used to identify the communication apparatus 101 and is, for example, an IP address used to identify the communication apparatus 101 in an IP network. For example, when the communication apparatus 101 establishes connection to the IP network through the network 110, the IP address is assigned to the communication apparatus 101 from the server 102.

In the description below, the description will be given taking an example of the IP address used to identify the communication apparatus 101 in the IP network as the identification information assigned from the server 102 and used to identify the communication apparatus 101.

To prevent depletion of the address resource, the server 102 releases the IP address assigned to the communication apparatus 101 that does not access the server 102 for a given time period (for example, 30 min). On the other hand, to continuously retain the assigned IP address, the communication apparatus 101 accesses the server 102 (known as an “always-on function”).

For example, the communication apparatus 101 transmits packets to the server 102 at predetermined cycles (for example, 28-min cycles). In this case, when access of the server 102 at the predetermined cycles increases, the power consumption of the communication apparatus 101 increases. When access of the server 102 to continuously receive the supply of the services increases, the power consumption increases. On the other hand, when the always-on function is completely released, no service may be received.

In the first embodiment, associated with turning “ON” or “OFF” of a screen, the communication apparatus 101 controls the accesses to the server 102 to continuously retain the assigned IP address. Triggered by the turning “OFF” of the screen, the communication apparatus 101 determines that a user uses no service supplied through the IP network and suspends the accessing of the server 102. Triggered by turning “ON” of the screen, the communication apparatus 101 determines that the user uses a service supplied through the IP network and restarts the accessing of the server 102. Thereby, electric-power saving of the communication apparatus 101 is facilitated by releasing the always-on function at a proper timing, preventing any degradation in usability.

The time intervals at which accesses to the server 102 are made to continuously retain the IP address assigned to the communication apparatus 101 may be periodic or non-periodic. However, in the description below, the description will be made taking an example of a case where the communication apparatus 101 periodically accesses the server 102.

A graph 120 depicted in FIG. 1 presents the power consumption of the communication apparatus 101. The power consumption varies over time (the vertical axis: electric current, the horizontal: time). A graph 130 presents time periods for the communication apparatus 101 to be able to receive a service (for example, a pushed service) supplied from the server 102. The services vary over time.

A “pushed service” is a type of service for which information is automatically distributed without any active operation by the user and is, for example, a pushed e-mail service or a pushed calendar synchronization service. In the graph 130, when the vertical axis represents “ON”, this represents that the communication apparatus 101 can receive the service and, when the vertical axis represents “OFF”, this represents that the communication apparatus 101 cannot receive any service.

With reference to the graph 120, one example will be described of a communication process of the communication apparatus 101 according to the first embodiment.

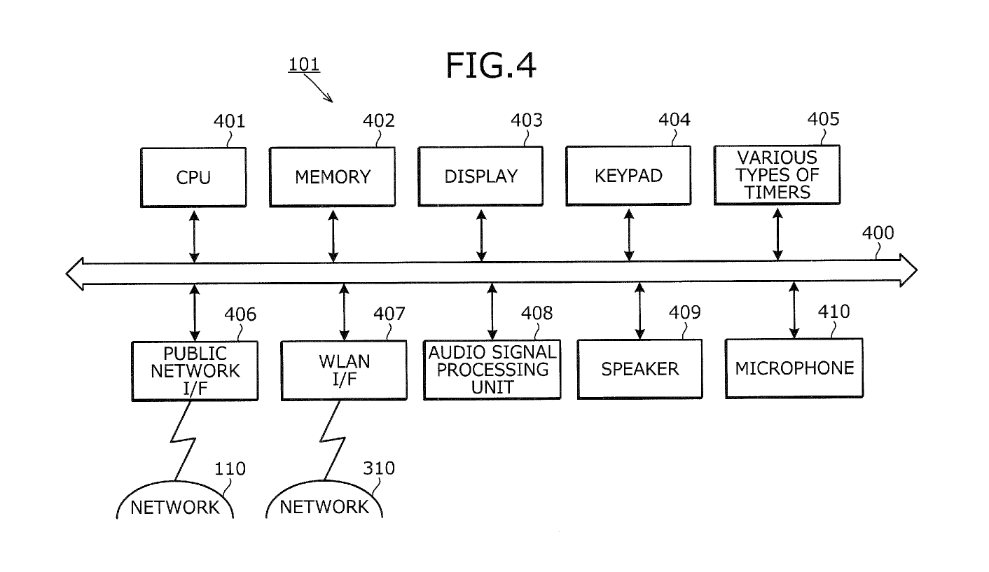

(1) The communication apparatus 101 detects that the display state of the screen transitions from “displaying” to “not displaying”. The screen is, for example, a display 403 depicted in FIG. 4 described later. For example, the communication apparatus 101 detects an operational input by the user to switch the display state of the screen from “displaying” to “not displaying” and thereby, detects that the display state of the screen transitions from “displaying” to “not displaying”.

(2) When the display state of the screen transitions from “displaying” to “not displaying”, the communication apparatus 101 suspends the periodic access of the server 102. For example, the communication apparatus 101 deletes access point name (APN) information in an APN list used to access the server 102 using the always-on function.

The “APN list” is a table that stores the APN information. The “APN information” is information that indicates the connection destination for the communication apparatus 101 to execute the data communication through the mobile communication network. For example, the communication apparatus 101 deletes the APN information in the APN list and thereby, no connection destination can be designated and consequently, no access of the server 102 is made by the always-on function.

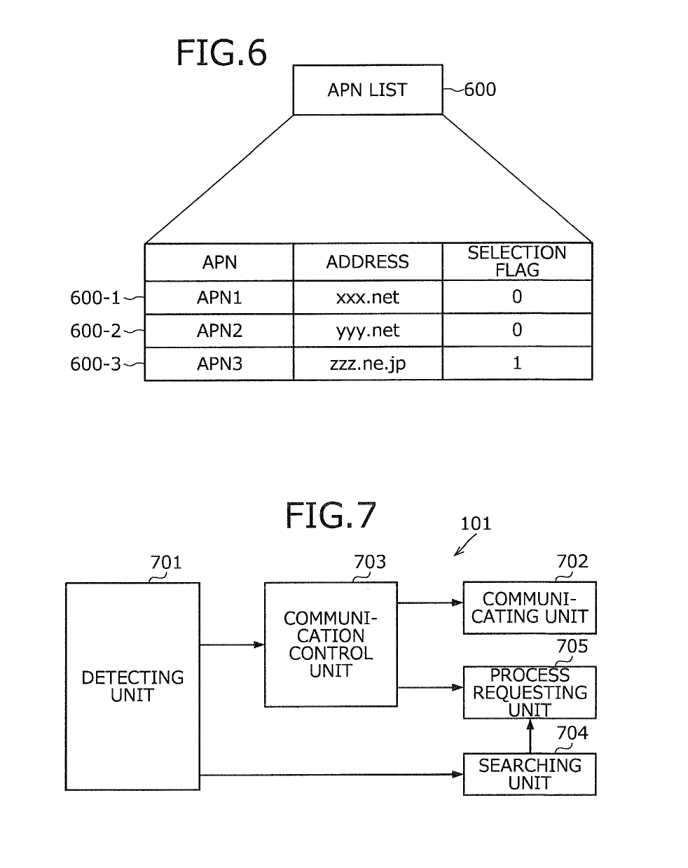

In the example of the graph 120, suspension of the periodic access of the server 102 reduces the power consumption by an amount corresponding to four accesses made to the server 102 by the always-on function, the accesses are made at the predetermined cycles (in this case, 28-min cycles). Detailed description of the APN list will be made with reference to FIG. 6.

(3) The communication apparatus 101 detects that the display state of the screen transitions from “not displaying” to “displaying”. For example, the communication apparatus 101 detects an operational input by the user to switch the display state of the screen from “not displaying” to “displaying” and thereby, detects that the display state of the screen transitions from “not displaying” to “displaying”.

(4) When the display state of the screen transitions from “not displaying” to “displaying”, the communication apparatus 101 restarts the periodic accessing of the server 102. For example, the communication apparatus 101 writes the APN information back into the APN list. Thereby, the connection destination can be designated for the communication apparatus 101 to execute the data communication through the mobile telephone network and therefore, periodic accessing of the server 102 by the always-on function is restarted. In this case, when the assigned IP address is released, a new IP address is acquired.

(5) When the periodic accessing of the server 102 is restarted, the communication apparatus 101 transmits to the server 102, a process request for a service supplied by the server 102. As a result, for example, various services are executed such as the e-mail service, the calendar synchronization service, and the contact address synchronization service that are supplied to the communication apparatus 101.

For example, the communication apparatus 101 executes a reception process for an e-mail, and synchronization processes such as the calendar synchronization and the contact address synchronization. The “calendar synchronization” and the “contact address synchronization” are each, for example, a process to establish synchronization between the communication apparatus 101 and a PC used by the user of the communication apparatus 101, based on the calendar or the contact address. Thereby, among the services supplied from the server 102, the services can be executed that cannot be received during the suspension of the periodic accessing of the server 102.

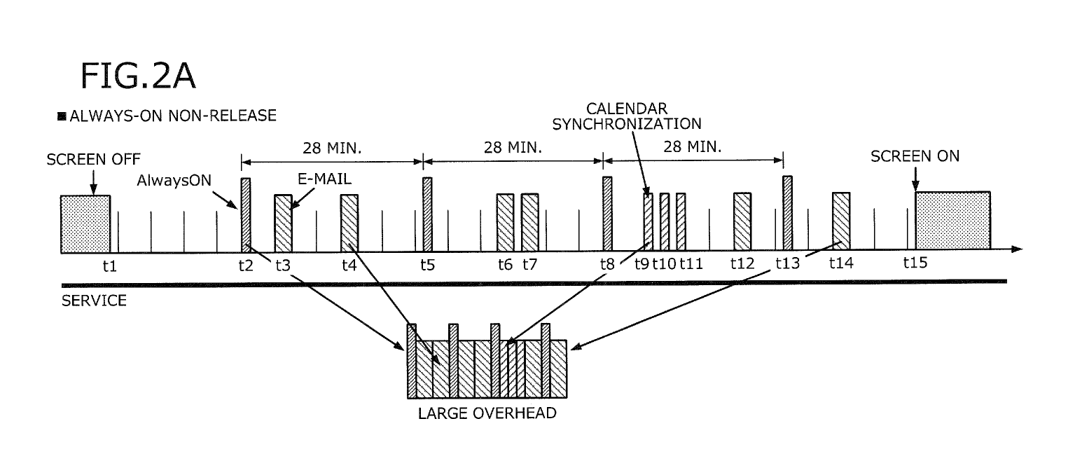

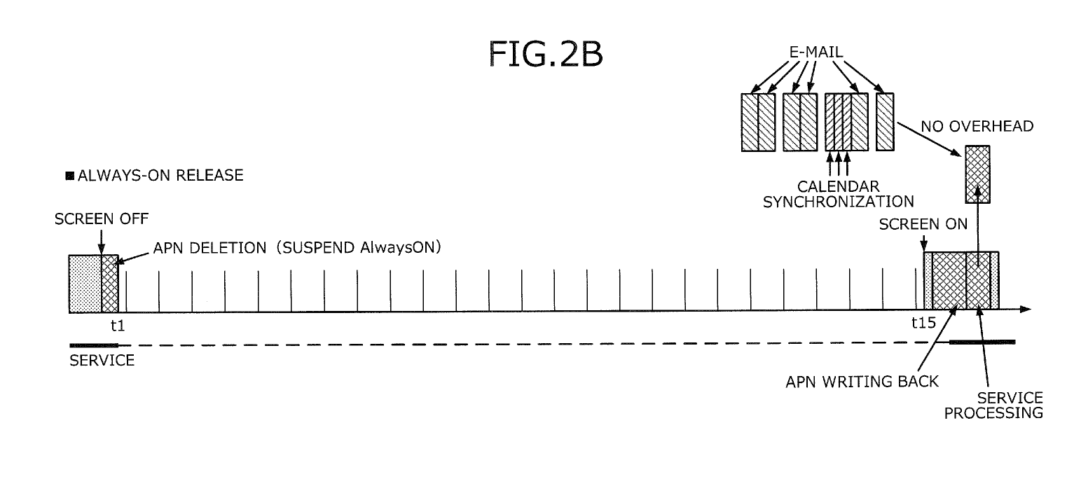

An example of operation of the communication apparatus 101 will be described with reference to FIGS. 2A and 2B for a case where plural services that cannot be received during the suspension of the periodic accessing of the server 102 are collectively executed when the accessing of the server 102 is restarted.

FIGS. 2A and 2B are explanatory diagrams of an example of operation of the communication apparatus 101. FIG. 2A depicts an example of operation of the communication apparatus 101 for a case when the always-on function is not released. FIG. 2B depicts an example of operation of the communication apparatus 101 for a case where the always-on function is released associated with the turning “ON” or “OFF” on the screen.

In the example depicted in FIG. 2A, at a time point t1, the display state of the screen transitions from “displaying” to “not displaying”; at time points t2, t5, t8, and t13, accesses are made by the always-on function to the server 102 (in this case, 28-min cycles); at time points t3, t4, t6, t7, t12, and t14, reception processes each for an e-mail are executed by the e-mail service supplied from the server 102; at time points t9, t10, and t11, the synchronization processes each for a calendar are executed by the calendar synchronization service supplied from the server 102; and, at a time point t15, the display state of the screen transitions from “not displaying” to “displaying”.

On the other hand, in the example depicted in FIG. 2B, at the time point t1, the display state of the screen transitions from “displaying” to “not displaying”. As a result, the periodic accessing of the server 102 is suspended. At the time point t15, the display state of the screen transitions from “not displaying” to “displaying”. As a result, the accessing of the server 102 is restarted and the various services supplied from the server 102 are intensively processed. For example, the reception processes for six e-mails and three synchronization processes for the calendar are collectively executed, that cannot be received during the suspension of the periodic accessing of the server 102.

Overhead is generated due to, for example, a startup process and a shutdown process, for each of the various processes executed by the communication apparatus 101. The “startup process” is, for example, a process of starting up a central processing unit (CPU) by restarting the supply of the power to the CPU. The “shutdown process” is, for example a process of shutting down the CPU by suspending the supply of the power to the CPU.

Therefore, as depicted in FIG. 2A, when the various processes executed at the time points t2 to t14 are executed at different timings separately from each other, overhead is generated for each of the various processes and therefore, the power consumption of the communication apparatus 101 increases.

On the other hand, as depicted in FIG. 2B, the overheads can be reduced by collectively executing the various services when the periodic accessing of the server 102 is restarted. For example, when the display state of the screen transitions from “not displaying” to “displaying”, the various services are collectively executed and thereby, the overheads can be reduced compared to the case where the various services are each executed at a timing different from that of each other. Therefore, the power consumption of the communication apparatus 101 can be suppressed.

According to the communication apparatus 101 according to the first embodiment, the periodic accessing of the server 102 is controlled associated with the transition of the display state of the screen and thereby, the power consumption of the communication apparatus 101 can be suppressed. In the example of FIG. 1, the always-on function is released during a time period PT for the display state of the screen to be “not displaying” and thereby, the power consumption can be reduced by an amount that corresponds to four transmission processes of packets to the server 102 executed by the always-on function.

According to the communication apparatus 101, the processing request is issued for the service supplied from the server 102 when the accessing to the server 102 is restarted and thereby, the services can be executed that cannot be received during the suspension of the accessing to the server 102. In this case, the plural services are collectively and intensively processed that cannot be received during the suspension of the periodic accessing of the server 102 and thereby, the power consumption of the communication apparatus 101 can be suppressed by reducing the overhead generated during the execution of the processes.

However, a case may be present where the services supplied from the server 102 are continuously used even when the display state of the screen transitions from “displaying” to “not displaying” (for example, during downloading of content). In this case, even when periodic access of the server 102 is suspended, the communication with the server 102 is continuously executed during the use of any one of the services and therefore, the IP address is not released.

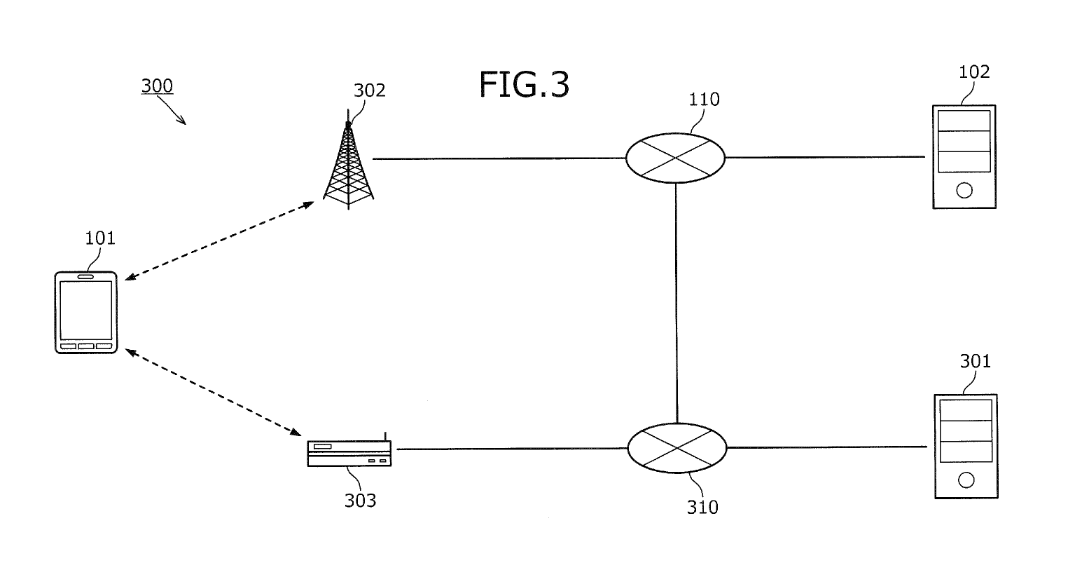

An example of a system configuration of a communication system 300 according to the first embodiment will be described. FIG. 3 is an explanatory diagram of an example of a system configuration of the communication system 300 according to the first embodiment. In FIG. 3, the communication system 300 includes the communication apparatus 101, the server 102, a control server 301, a base station 302, and an access point (hereinafter, referred to as “AP”) 303.

In the communication system 300, the communication apparatus 101, the server 102, the control server 301, the base station 302, and the AP 303 are connected to each other through the wired or the wireless networks 110 and 310. The network 110 is, for example, mobile communications network (a mobile telephone network). The network 310 is, for example, an IP network (the Internet).

The communication apparatus 101 is a computer used by the user of the communication system 300. The server 102 is the computer supplying the services to the communication apparatus 101 as above. For example, the server 102 relays the services supplied from the control server 301 to the communication apparatus 101. The function of the server 102 is implemented by, for example, a cooperative operation of a domain name system (DNS) server, a dynamic host configuration protocol (DHCP) server, an access server, etc., of the communication common carrier.

The control server 301 is a computer of the supply source of the services. For example, the control server 301 supplies the services to the communication apparatus 101 through the server 102 of the communication common carrier. A function of the control server 301 is implemented by, for example, a cooperative operation of a mail server, a web server, an application server, a database server, etc.

The base station 302 is one among scattered wireless base stations of the mobile communication network. The communication apparatus 101 can access the server 102 by, for example, establishing connection to the network 110 through the base station 302. The AP 303 is one of the scattered access points of a wireless local area network (LAN). The communication apparatus 101 can access the control server 301 by, for example, establishing connection to the network 310 through the AP 303.

The server 102 can access the control server 301 through the network 310. In the example of FIG. 3, the communication apparatus 101 can communicate with the server 102 connected to the networks 110 and 310, through the network 110, and is assigned an IP address used to identify the communication apparatus 101 in the network 310, by the server 102.

Though FIG. 3 depicts only one set of each of the communication apparatus 101, the server 102, the control server 301, the base station 302, and the AP 303, the number of each of the components is not limited to one. For example, the communication apparatus 101 may be disposed for each user of the communication system 300; the server 102 may be disposed for each communication common carrier; and the control server 301 may be disposed for each service supplier.

FIG. 4 is a block diagram of an example of a hardware configuration of the communication apparatus 101 according to the first embodiment. In FIG. 4, the communication apparatus 101 includes a CPU 401, memory 402, a display 403, a keypad 404, various types of timers 405, a public network interface (I/F) 406, a wireless LAN (WLAN) I/F 407, an audio signal processing unit 408, a speaker 409, and a microphone 410. These components are connected to each other by a bus 400.

The CPU 401 supervises the control of the overall communication apparatus 101. The memory 402 includes, for example, read only memory (ROM), random access memory (RAM), and flash ROM. For example, the flash ROM stores a program of an operating system (OS); the ROM stores application programs; and the RAM is used as a work area of the CPU 401. Each of the programs stored in the memory 402 causes the CPU 401 to execute a coded process when the program is loaded on the CPU 401.

The display 403 displays data such as a document, an image, or function information in addition to a cursor, an icon, or a toolbox. For example, a liquid crystal display or an organic electroluminescence (EL) display can be employed as the display 403.

The keypad 404 includes keys to input characters, numbers, various instructions, etc., and executes inputting of data; and may be, for example, a touch panel input pad or a numerical keypad. The various types of timers 405 each count time. The various types of timers 405 can be, for example, a screen off timer and an always-on timer described later.

The public network I/F 406 is connected to the network 110 through the mobile telephone network; is connected to other apparatuses (for example, the server 102) through the network 110; supervises the interface between the network 110 and the internal components; and controls inputs and outputs of data from/to the other apparatuses.

The WLAN I/F 407 is connected to the network 310 through the wireless LAN; is connected to other apparatuses (for example, the control server 301) through the network 310; supervises the interface between the network 310 and the internal components; and controls the input and output of data with respect to other apparatuses.

The audio signal processing unit 408 is connected to the speaker 409 and the microphone 410. For example, sound received by the microphone 410 is A/D-converted by the audio signal processing unit 408. The speaker 409 outputs sound.

Though not depicted, the communication apparatus 101 includes, for example, a memory controller that controls reading and writing of data with respect to the memory 402; a power management unit (PMU) that supplies a power source voltage to the components; a battery; and a global positioning system (GPS) unit, in addition to the above components.

A hardware configuration example of the server 102 and the control server 301 depicted in FIG. 3 will be described. For simplification, in the description, the server 102 and the control server 301 will be simply indicated as “server 102, etc.”

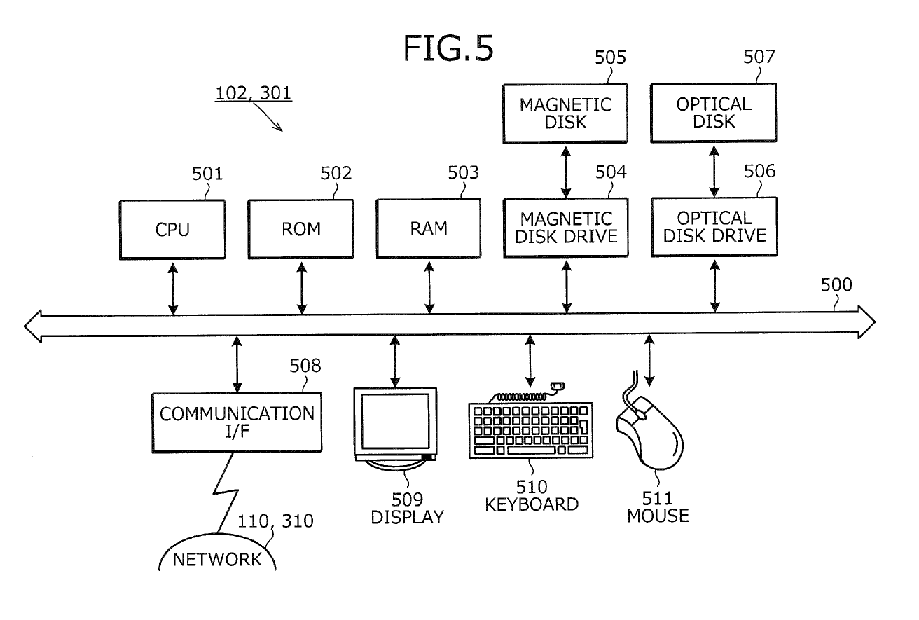

FIG. 5 is a block diagram of a hardware configuration example of the server 102, etc. according to the first embodiment. As depicted in FIG. 5, the server 102, etc. include a central processing unit (CPU) 501, read-only memory (ROM) 502, random access memory (RAM) 503, a magnetic disk drive 504, a magnetic disk 505, an optical disk drive 506, an optical disk 507, an interface (I/F) 508, a display 509, a keyboard 510, and a mouse 511, respectively connected by a bus 500.

The CPU 501 governs overall control of the server 102, etc. The ROM 502 stores therein programs such as a boot program. The RAM 503 is used as a work area of the CPU 501. The magnetic disk drive 504, under the control of the CPU 501, controls the reading and writing of data with respect to the magnetic disk 505. The magnetic disk 505 stores therein data written under control of the magnetic disk drive 504.

The optical disk drive 506, under the control of the CPU 501, controls the reading and writing of data with respect to the optical disk 507. The optical disk 507 stores therein data written under control of the optical disk drive 506, the data being read by a computer.

The I/F 508 is connected to the networks 110, 310 through a communication cable or by wireless communication, and is connected to other apparatuses (e.g., the communication apparatus 101) through the networks 110, 310. The I/F 508 administers an internal interface with the networks 110, 310 and controls the input and output of data with respect to external apparatuses. For example, a modem or a LAN adaptor may be employed as the I/F 508.

The display 509 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 509.

The keyboard 510 includes, for example, keys for inputting letters, numerals, and various instructions and performs the input of data. Alternatively, a touch-panel-type input pad or numeric keypad, etc. may be adopted. The mouse 511 is used to move the cursor, select a region, or move and change the size of windows. A track ball or a joy stick may be adopted provided each respectively has a function similar to a pointing device.

The server 102, etc., may omit, for example, the optical disk drive 506, the optical disk 507, the display 509, the keyboard 510, and the mouse 511 among the above components.

The contents of the APN list used by the communication apparatus 101 will be described. The APN list is stored in the memory 402 depicted in FIG. 4. FIG. 6 is an explanatory diagram of an example of the contents of the APN list. In FIG. 6, an APN list 600 has fields for the APN, the address, and the selection flag, and by setting information in each field causes APN information 600-1 to 600-3 to be stored as records.

The “APN” is the name representing an access point of the connection destination (in the example of FIG. 3, the server 102) used when the communication apparatus 101 executes data communication through the network 110 (the mobile communication network). The “address” is the address of the APN. The “selection flag” is a flag indicating the APN currently selected. In FIG. 6, “1” is set for the selection flag of the APN currently selected and “0” is set for the selection flag of the APN currently not selected.

Taking an example of the APN information 600-3, the APN “APN 3” currently selected as the access point of the connection destination and the address “zzz.ne.jp” thereof are presented that are used when the communication apparatus 101 executes the data communication through the network 110. The APN of the connection destination can be selected arbitrarily by, for example, an operational input by the user via the keypad 404 depicted in FIG. 4.

FIG. 7 is a block diagram of an example of a functional configuration of the communication apparatus 101 according to the first embodiment. In FIG. 7, the communication apparatus 101 includes a detecting unit 701, a communicating unit 702, a communication control unit 703, a searching unit 704, and a process requesting unit 705. The functional units (the units from the detecting unit 701 to the process requesting unit 705) forming a control unit are implemented by, for example, causing the CPU 401 to execute programs stored in the memory 402 depicted in FIG. 4 or by using the public network I/F 406 and the WLAN I/F 407. The processing result of each of the functional units is, for example, stored to the memory 402.

The detecting unit 701 has a function of detecting that the display state of the display 403 transitions from “displaying” to “not displaying”. For example, when the display state of the display 403 is switched from “displaying” to “not displaying” by operational input by the user via the keypad 404, the detecting unit 701 detects that the display state of the display 403 transitions from “displaying” to “not displaying”. The detecting unit 701 may detect that the display state of the display 403 transitions from “displaying” to “not displaying” when the value of a screen off timer included among the various types of timers 405 depicted in FIG. 4 reaches a specified value T1.

The screen off timer is, for example, a timer that measures a time period necessary for the display state of the display 403 to transition from “displaying” to “not displaying”. The “specified value T1” is a value representing a specified time period necessary for the display state of the display 403 to transition from “displaying” to “not displaying” (for example, 15 seconds); and is, for example, set in advance and stored in the memory 402. The detecting unit 701 may also detect that the display state of the display 403 transitions from “displaying” to “not displaying” when the power consumption mode of the display 403 transitions to an electric power saving mode by suppressing the supply of the power to the display 403.

The detecting unit 701 also has a function of detecting that the display state of the display 403 transitions from “not displaying” to “displaying”. For example, when the display state of the display 403 is switched from “not displaying” to “displaying” by operational input by the user via the keypad 404, the detecting unit 701 detects that the display state of the display 403 transitions from “not displaying” to “displaying”. The detecting unit 701 may detect that the display state of the display 403 transitions from “not displaying” to “displaying” when an application to be started up at a time determined in advance (for example, an alarm) is started up.

The communicating unit 702 has a function of accessing the server 102. “Accessing of the server 102” is, for example, periodic packet communication to confirm that the connection between the communication apparatus 101 and the server 102 is available (always-on function). The server 102 receives a packet from the communication apparatus 101 and thereby, determines that communication is executed using the IP address assigned to the communication apparatus 101.

For example, the communicating unit 702 transmits to the server 102, a keep-alive packet (that may include the IP address) that includes an identifier specific to the apparatus, via the public network I/F 406. The communicating unit 702 periodically accesses the server 102 to confirm that the connection between the communication apparatus 101 and the server 102 is available.

For example, when the value of the always-on timer included in the various types of timers 405 reaches a specified value T2, the communicating unit 702 refers to the APN list 600 depicted in FIG. 6; identifies the APN “APN 3” currently selected as the access point of the connection destination; designates the address “zzz.ne.jp” of the identified APN “APN 3”; thereby, is connected to the network 110 by the public network I/F 406; and transmits the keep-alive packet to the server 102.

The always-on timer is a timer that measures the time until the time when the communication apparatus 101 accesses the server 102 using the always-on function. The “specified value T2” is a value that represent a specified time period until the time when the communication apparatus 101 accesses the server 102 using the always-on function (for example, 28 min); and is, for example, set in advance and stored in the memory 402.

The communication control unit 703 has a function of suspending the periodic access of the server 102 by controlling the communicating unit 702 when the detecting unit 701 detects that the display state of the display 403 transitions from “displaying” to “not displaying”. For example, the communications control unit 703 copies the APN information in the APN list 600 (for example, the APN information 600-1 to 600-3) into a specific storage area of the memory 402; and deletes the APN information in the APN list 600.

Thus, the communicating unit 702 cannot identify the APN currently selected as the connection destination access point and the address of the APN and therefore, the periodic access of the server 102 by the always-on function can be suspended. The specific storage area is set in advance in any one of storage areas in the memory 402.

The communication control unit 703 further has a function of restarting periodic access of the server 102 by controlling the communicating unit 702 when the detecting unit 701 detects that the display state of the display 403 transitions from “not displaying” to “displaying”. For example, the communication control unit 703 reads the APN information copied into the specific storage area and writes the read APN information into the APN list 600.

Thus, the communicating unit 702 can identify the APN currently selected as the connection destination access point and the address of the APN and therefore, the periodic access of the server 102 by the always-on function can be restarted.

After the communication control unit 703 writes the APN information back into the APN list 600, for example, when the value of the always-on timer reaches the specified value T2, the communicating unit 702 accesses the server 102. However, the communication control unit 703 may control the communicating unit 702 to access the server 102 after writing the APN information back into the APN list 600. In this case, the always-on timer is reset.

The searching unit 704 has a function of searching for the AP 303 of the wireless LAN (see FIG. 3) when the detecting unit 701 detects that the display state of the display 403 transitions from “not displaying” to “displaying”. As described, the AP 303 is one of the scattered access points of the wireless LAN.

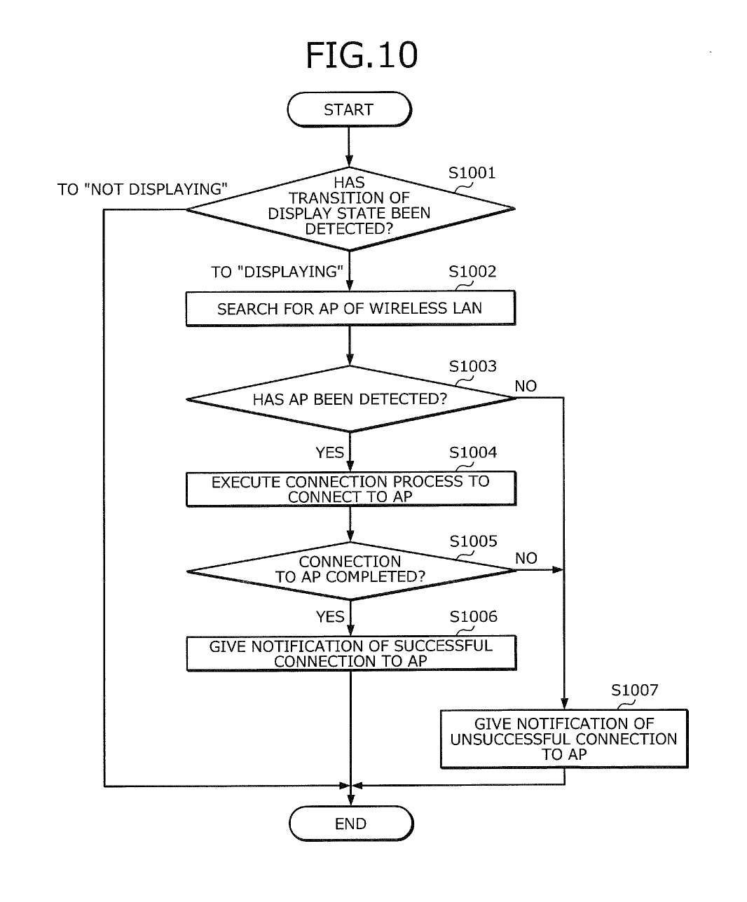

For example, the searching unit 704 detects an accessible AP 303 using the WLAN I/F 407. When the searching unit 704 detects the AP 303, the searching unit 704 executes a connection process to connect to the detected AP 303. Notification of the result as to whether the connection is established with the AP 303 (successful connection or failed connection) is given to, for example, the process requesting unit 705 described later. The specific process content of the searching unit 704 will be described with reference to a flowchart depicted in FIG. 10.

The process requesting unit 705 has a function of transmitting to the server 102 a process request for a service when periodic access of the server 102 is restarted. For example, the “service” is a service supplied from the control server 301 through the server 102 and is an e-mail service, a calendar synchronization service, or a contact address synchronization service.

For example, when the APN information is written into the APN list 600, the process requesting unit 705 refers to the APN list 600; identifies the APN currently selected as the connection destination access point; and designates the address of the identified APN. Thereby, the public network I/F 406 establishes connection to the network 110 to access the server 102.

In this case, if no IP address is assigned (for example, if the IP address has been released), an IP address acquisition process is executed. The process requesting unit 705 transmits to the server 102, a process request for a service to be delivered to the control server 301. A “process request for a service” is, for example, a transmission request for e-mail, a synchronization request for a calendar or a contact address.

The service to be processed is, for example, included in a list in advance as an application to be processed and is stored in the memory 402. For example, the process requesting unit 705 refers to the list stored in the memory 402, starts up the application to be processed, and thereby, transmits the process request for the service. As a result of the transmission of the process request for the service, the process requesting unit 705 executes the reception process for e-mail or the synchronization process for a calendar or a contact address.

When the connection is established to the AP 303 of the wireless LAN, the process requesting unit 705 may establish connection to the network 310 via the WLAN I/F 407 and may transmit the process request for the service, to the control server 301. In a case where periodic access of the server 102 is restarted, when connection to the AP 303 is established, the process requesting unit 705 transmits the process request for the service to the control server 301 through the wireless LAN. Thereby, the service can be processed using the wireless LAN, which can communicate at a speed higher than that of the mobile telephone network.

When periodic access of the server 102 is restarted, the process requesting unit 705 may transmit the process request for the service after a given time period elapses. For example, the process requesting unit 705 may transmit the process request for the service to the server 102 when the value of a synchronization start timer included among the various types of timers 405 reaches a specified value T3.

The “synchronization start timer” is a timer that measures the time period that elapses since the restart of the periodic accessing of the server 102. The “specified value T3” is a value that represents a specified time period (for example, one min) from the restart of the periodic accessing of the server 102 until the execution of the service. The specified value T3 is, for example, set in advance and stored in the memory 402.

Thus, the service is executed not immediately after the switching of the display state of the display 403 from “not displaying” to “displaying” but after a preliminarily set time period elapses after the switching. As a result, any degradation can be prevented of the usability due to an increase of the load on the CPU 401 immediately after the switching of the display state of the display 403 from “not displaying” to “displaying”. For example, the timing at which the synchronization start timer is started may be a time after the APN information is written back into the APN list 600 or may be a time after the process requesting unit 705 receives from the searching unit 704, the connection result of the connection to the AP 303.

In a case where the periodic accessing of the server 102 is restarted, when the use rate of the CPU 401 is less than or equal to a predetermined threshold value, the process requesting unit 705 may transmit the process request for the service. The “predetermined threshold value (for example, 30%)” is, for example, set in advance and stored in the memory 402. Thus, after the display state of the display 403 is switched from “not displaying” to “displaying”, the service can be executed after waiting for the load on the CPU 401 to become low.

In the description above, the communication control unit 703 causes the periodic accessing of the server 102 to suspend by deleting the APN information in the APN list 600. However, configuration is not limited hereto. For example, the communication control unit 703 may cause the periodic accessing of the server 102 to suspend by stopping the always-on timer, or may cause the periodic accessing of the server 102 to restart by restarting the always-on timer.

In the description above, for example, the process requesting unit 705 transmits a process request for a service to the server 102, when the periodic accessing of the server 102 is restarted. However, configuration is not limited hereto. For example, when the process request for the service is received by operational input by the user after the periodic accessing of the server 102 has restarted, the process requesting unit 705 may transmit the process request for the service to the server 102.

A procedure for the communication process of the communication apparatus 101 according to the first embodiment will be described.

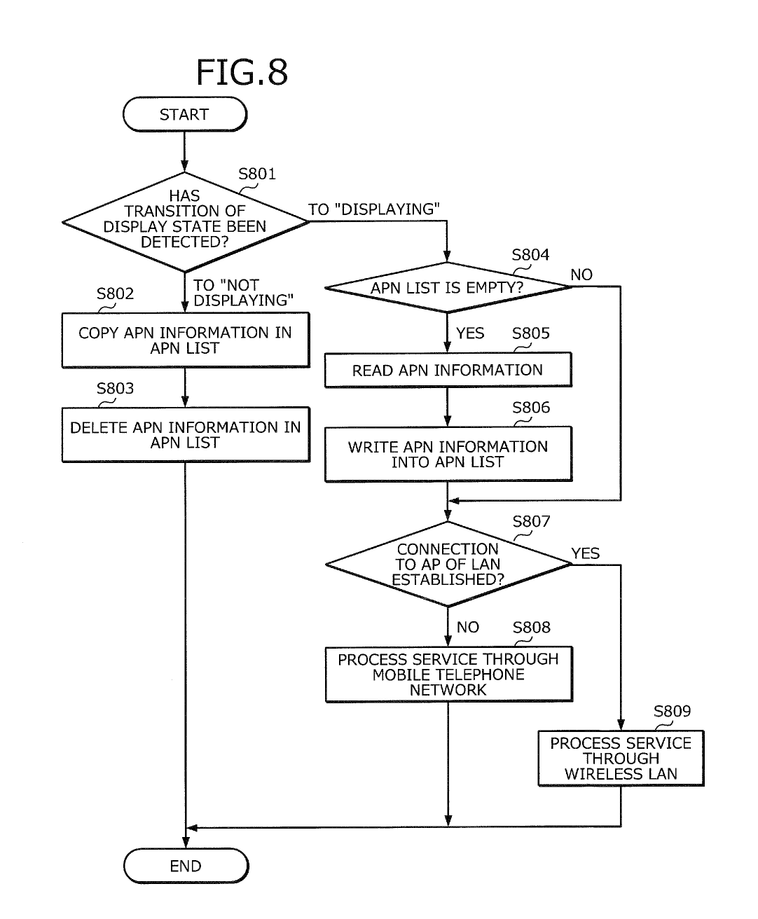

FIG. 8 is a flowchart of an example of a procedure (Part I) for the communication process of the communication apparatus 101 according to the first embodiment. In the flowchart depicted in FIG. 8, the detecting unit 701 determines whether a transition of the display state of the display 403 has been detected (step S801).

If the detecting unit 701 determines that transition of the display state of the display 403 from “displaying” to “not displaying” has been detected (step S801: TO “NOT DISPLAYING”), the communication control unit 703 copies the APN information in the APN list 600 into the specific storage area of the memory 402 (step S802), deletes the APN information in the APN list 600 (step S803), and causes the series of process steps according to the flowchart to come to an end.

If the detecting unit 701 determines at step S801 that transition of the display state of the display 403 from “not displaying” to “displaying” has been detected (step S801: TO “DISPLAYING”), the communication control unit 703 determines whether the APN list 600 is empty (step S804). The APN list 600 being empty indicates that the APN information has been deleted, and that the always-on function has been released.

If the communication control unit 703 determines that the APN list 600 is not empty (step S804: NO), the procedure advances to step S807. On the other hand, if the communication control unit 703 determines that the APN list 600 is empty (step S804: YES), the communication control unit 703 reads the APN information copied in the specific storage area of the memory 402 (step S805) and writes the read APN information into the APN list 600 (step S806).

The process requesting unit 705 determines whether the connection to the AP 303 of the wireless LAN is established (step S807). If the process requesting unit 705 determines that no connection to the AP 303 has been established (step S807: NO), the process requesting unit 705 processes the service through the mobile telephone network using the public network I/F 406 (step S808) and causes the series of process steps according to the flowchart to come to an end.

If the process requesting unit 705 determines at step S807 that the connection to the AP 303 is established (step S807: YES), the process requesting unit 705 processes the service through the wireless LAN using the WLAN I/F 407 (step S809) and causes the series of process steps according to the flowchart to come to an end.

If the IP address assigned to the communication apparatus 101 is released at step S808, the IP address acquisition process is executed.

Thus, the periodic accessing of the server 102 can be controlled associated with the transition of the display state of the display 403. The services that cannot be received during the suspension of the periodic accessing of the server 102 can be executed when the display state of the display 403 transitions from “not displaying” to “displaying”.

A procedure (Part II) for the communication process of the communication apparatus 101 according to the first embodiment will be described. For the procedure (Part II) for the communication process of the communication apparatus 101, the case will be described where, when the periodic accessing of the server 102 is restarted, the service is executed after a given time period elapses.

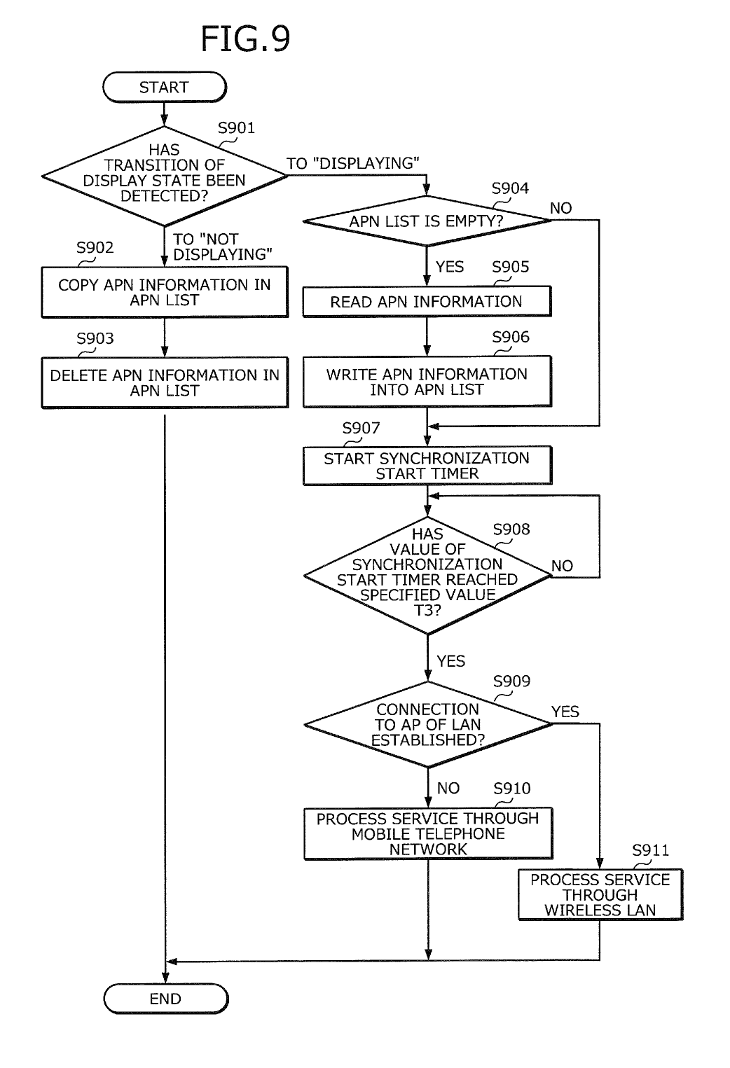

FIG. 9 is a flowchart of an example of a procedure (Part II) for the communication process of the communication apparatus 101 according to the first embodiment. In the flowchart depicted in FIG. 9, the detecting unit 701 determines whether a transition of the display state of the display 403 has been detected (step S901).

If the detecting unit 701 determines that transition of the display state of the display 403 from “displaying” to “not displaying” has been detected (step S901: TO “NOT DISPLAYING”), the communication control unit 703 copies the APN information in the APN list 600 into the specific storage area of the memory 402 (step S902), deletes the APN information in the APN list 600 (step S903), and causes the series of process steps according to the flowchart to come to an end.

If the detecting unit 701 determines at step S901 that transition of the display state of the display 403 from “not displaying” to “displaying” has been detected (step S901: TO “DISPLAYING”), the communication control unit 703 determines whether the APN list 600 is empty (step S904). If the communication control unit 703 determines that the APN list 600 is not empty (step S904: NO), the procedure advances to step S907.

On the other hand, if the communication control unit 703 determines that the APN list 600 is empty (step S904: YES), the communication control unit 703 reads the APN information copied in the specific storage area of the memory 402 (step S905) and writes the read APN information into the APN list 600 (step S906).

The process requesting unit 705 starts the synchronization start timer (step S907) and determines whether the value of the synchronization start timer has reached the specified value T3 (step S908). The process requesting unit 705 waits for the value of the synchronization start timer to reach the specified value T3 (step S908: NO).

When the process requesting unit 705 determines that the value of the synchronization start timer has reached the specified value T3 (step S908: YES), the process requesting unit 705 determines whether the connection is established to the AP 303 of the wireless LAN (step S909). If the process requesting unit 705 determines that the connection to the AP 303 is not established (step S909: NO), the process requesting unit 705 processes the service through the mobile telephone network using the public network I/F 406 (step S910) and causes the series of process steps according to the flowchart to come to an end.

If the process requesting unit 705 determines at step S909 that the connection to the AP 303 is established (step S909: YES), the process requesting unit 705 processes the service through the wireless LAN using the WLAN I/F 407 (step S911) and causes the series of process steps according to the flowchart to come to an end.

If the IP address assigned to the communication apparatus 101 is released at step S910, the IP address acquisition process is executed.

Thus, after the display state of the display 403 is switched from “not displaying” to “displaying”, the service can be executed after a short time period elapses.

A procedure for a search process to search for the AP 303 of the wireless LAN will be described.

FIG. 10 is a flowchart of an example of a procedure for the search process of the communication apparatus 101 according to the first embodiment. In the flowchart depicted in FIG. 10, the searching unit 704 determines whether the detecting unit 701 has detected any transition of the display state of the display 403 (step S1001).

If the searching unit 704 determines that the detecting unit 701 has detected transition of the display state of the display 403 from “not displaying” to “displaying” (step S1001: TO “DISPLAYING”), the searching unit 704 searches for the AP 303 of the accessible wireless LAN using the WLAN I/F 407 (step S1002) and determines whether the WLAN I/F 407 has detected an AP 303 (step S1003).

If the searching unit 704 determines that the WLAN I/F 407 has not detected an AP 303 (step S1003: NO), the procedure advances to step S1007. On the other hand, if the searching unit 704 determines that the WLAN I/F 407 has detected an AP 303 (step S1003: YES), the searching unit 704 executes the connection process to connect to the detected AP 303 (step S1004) and determines whether connection to the AP 303 has been completed (step S1005).

If the searching unit 704 determines that connection to the AP 303 has been completed (step S1005: YES), the searching unit 704 notifies the process requesting unit 705 of a connection result indicating successful connection to the AP 303 (step S1006) and causes the series of process steps according to the flowchart to come to an end.

On the other hand, if the searching unit 704 determines that connection to the AP 303 has not yet been completed (step S1005: NO), the searching unit 704 notifies the process requesting unit 705 of a connection result indicating unsuccessful connection to the AP 303 (step S1007) and causes the series of process steps according to the flowchart to come to an end.

If the searching unit 704 determines at step S1001 that the detecting unit 701 has detected transition of the display state of the display 403 from “displaying” to “not displaying” (step S1001: TO “NOT DISPLAYING”), the searching unit 704 causes the series of process steps to come to an end. Thus, the AP 303 of the wireless LAN can be searched for.

As described, according to the communication apparatus 101 of the first embodiment, when the display state of the display 304 transitions from “displaying” to “not displaying”, periodic accessing of the server 102 can be suspended. Thereby, the power consumption of the communication apparatus 101 can be suppressed by suspending the operation of the always-on function during the time period during which it is thought that the user does not use any service through the network 310.

According to the communication apparatus 101 of the first embodiment, when the display state of the display 403 transitions from “not displaying” to “displaying”, the periodic accessing of the server 102 can be restarted. Thus, when it is thought that the user restarts the use of the service through the network 310, any degradation of the usability can be prevented by restarting the operation of the always-on function.

For example, a standby time period of the communication apparatus 101 is set to be “210 hours” when the always-on function is not released. On the contrary, according to the present communication method, the standby time period of the communication apparatus 101 can be extended to, for example, about “330 hours” when the always-on function is released.

According to the communication apparatus 101 of the first embodiment, when the periodic accessing of the server 102 is restarted, a process request for a service can be transmitted to the server 102. Thereby, the services that cannot be received during the suspension of the periodic accessing of the server 102 can be executed. Collectively and intensively processing the plural services can suppress the power consumption of the communication apparatus 101 by reducing the overhead generated during the execution of the processes.

According to the communication apparatus 101 according to the first embodiment, when the periodic accessing of the server 102 is restarted, the process request for the service can be transmitted to the server 102 after the given time period elapses since the transition of the display state of the display 403 from “not displaying” to “displaying”. Thus, any degradation of the usability caused by an increase of the load on the CPU 401 immediately after the display state of the display 403 is switched from “not displaying” to “displaying” can be prevented.

A communication apparatus 101 according to a second embodiment will be described. Parts identical to those described in the first embodiment will be given the same reference numerals used in the first embodiment and will not again be described.

A case has been described in the first embodiment where the periodic accessing of the server 102 is controlled associated with the transition of the display state of the display 403. In this case, when the display state of the display 403 frequently transitions, the power consumption of the communication apparatus 101 may increase for operations to suspend and restart the periodic accessing of the server 102.

For example, even in a case where the user currently uses any one of the functions watching the display 403, if the user executes no operational input, the value of the screen off timer reaches the specified value T1 (for example, 15 seconds) and the display state of the display 403 transitions from “displaying” to “not displaying”. In this case, it is assumed that an operational input by the user causes the display state of the display 403 to be immediately switched from “not displaying” to “displaying” and therefore, the display state of the display 403 may frequently transition.

Therefore, in the second embodiment, the periodic accessing of the server 102 is suspended when the display state of the display 403 transitions from “displaying” to “not displaying” and is “not displaying” continuously for a predetermined time period K1 (for example, 3 min or 5 min) since the transition. Thereby, the control of the periodic accessing of the server 102 is suppressed when the display state of the display 403 frequently transitions at short time intervals (for example, every 15 seconds).

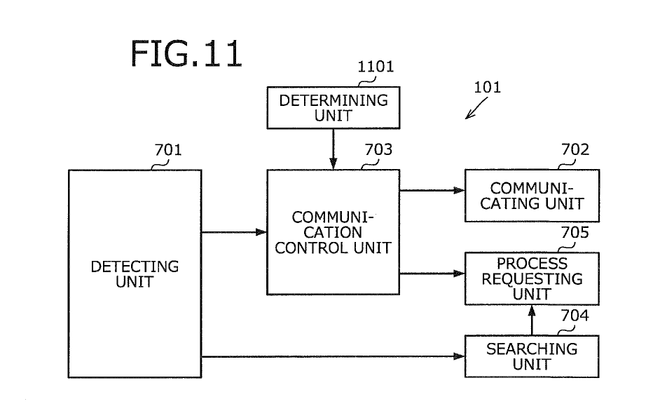

FIG. 11 is a block diagram of an example of a functional configuration of the communication apparatus 101 according to the second embodiment. In FIG. 11, the communication apparatus 101 includes the detecting unit 701, the communicating unit 702, the communication control unit 703, the searching unit 704, the process requesting unit 705, and a determining unit 1101. The functional units (the units from the detecting unit 701 to the process requesting unit 705 and the determining unit 1101) forming a control unit, are implemented by, for example, causing the CPU 401 to execute programs stored in the memory 402 or by using the public network I/F 406 and the WLAN I/F 407. The processing result of each of the functional units is, for example, stored to the memory 402.

The communication control unit 703 has a function of suspending the periodic accessing of the server 102 when the display state of the display 403 transitions from “displaying” to “not displaying” and is “not displaying” continuously for the predetermined time period K1 since the transition. For example, the communication control unit 703 may suspend the periodic accessing of the server 102 when the value of a deletion timer included among the various types of timers 405 reaches a specified value T4.

The “deletion timer” is, for example, a timer that measures the time period elapsing since the time when the display state of the display 403 transitions from “displaying” to “not displaying”. The “specified value T4” corresponds to the predetermined time period K1 and is a value that represents, for example, a specified time period (for example, 3 min or 5 min) since the transition of the display state of the display 403 from “displaying” to “not displaying”, until the suspension of the periodic accessing of the server 102. The specified value T4 is, for example, set in advance and stored in the memory 402.

The determining unit 1101 has a function of determining whether any communication with the server 102 occurs. For example, the determining unit 1101 determines whether packet communication through the network 110 has been executed with the server 102.

The case is present where, for example, communication with the server 102 occurs before the predetermined time period K1 elapses since the transition of the display state of the display 403 from “displaying” to “not displaying”. For example, the case is present where, for example, the communication apparatus 101 receives e-mail from the server 102 by packet communication through the network 110.

In this case, it is assumed, for example, that the display state of the display 403 is switched from “not displaying” to “displaying” by operational input by the user to view the received e-mail or to produce a reply e-mail. If the communication with the server 102 occurs before the predetermined time period K1 elapses, the predetermined time period K1 may newly be measured again to extend the time period until the time when the periodic accessing of the server 102 is suspended.

For example, the communication control unit 703 may reset and restart the deletion timer when the communication with the server 102 occurs before the predetermined time period K1 elapses since the transition of the display state of the display 403 from “displaying” to “not displaying”. The communication control unit 703 may further suspend the periodic accessing of the server 102 when the value of the deletion timer reaches the specified value T4.

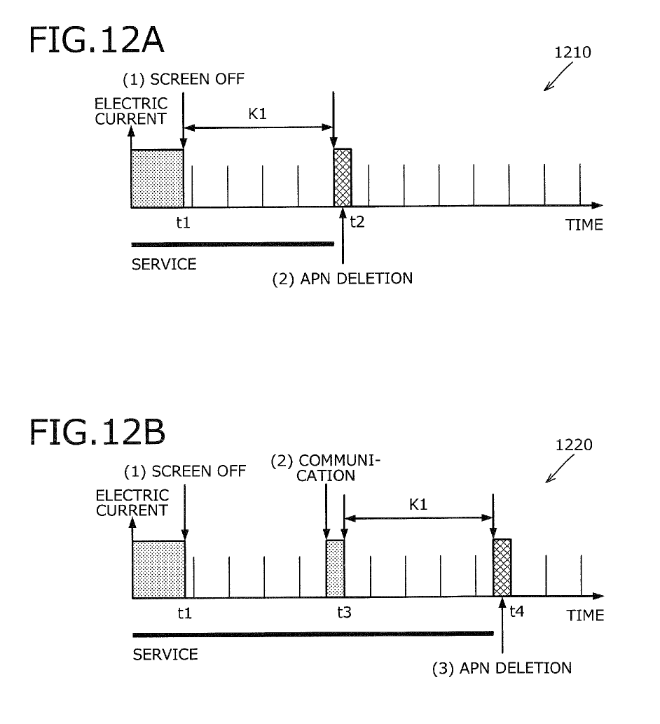

One example of a communication method according to the second embodiment will be described. FIGS. 12A and 12B are explanatory diagrams of an example of the communication method according to the second embodiment. In FIGS. 12A and 12B, each of graphs 1210 and 1220 presents the power consumption of the communication apparatus 101 that varies over time (the vertical axis: the electric current, the horizontal axis: time). In FIGS. 12A and 12B, horizontal bars depicted parallel to the time axes of the graphs 1210 and 1220 each represents the time period during which the communication apparatus 101 can receive the service supplied from the server 102.

In the example depicted in FIG. 12A, (1) at the time point t1, transition of the display state of the display 403 from “displaying” to “not displaying” is detected (in FIGS. 12A and 12B, “screen off”). (2) At the time point t2, the periodic accessing of the server 102 is suspended because the display state of the display 403 is “not displaying” continuously for the predetermined time period K1 from the transition of the display state of the display 403 to “not displaying” (in FIGS. 12A and 12B, “APN deletion”).

In this manner, when the display state of the display 403 is “not displaying” continuously for the predetermined time period K1, the suspension of the periodic accessing of the server 102 can suppress the access control executed when the transition of the display state frequently occurs at short time intervals.

Thereby, any increase can be suppressed of the power consumption of the communication apparatus 101 necessary for the operations to suspend and restart the periodic accessing of the server 102. Any increase of the communication volume due to the communication with the server 102 can be suppressed when the periodic accessing of the server 102 is restarted. Any degradation of the usability can be prevented when the display state of the display 403 frequently transitions at short time intervals.

In the example depicted in FIG. 12B, (1) at the time point t1, it is detected that the display state of the display 403 transitions from “displaying” to “not displaying” (in FIGS. 12A and 12B, “screen off”). (2) At the time point t3, the communication with the server 102 occurs before the predetermined time period K1 elapses since the transition of the display state of the display 403 from “displaying” to “not displaying” (in FIGS. 12A and 12B, “communication occurrence”). (3) At the time point t4, the periodic accessing of the server 102 is suspended because the display state of the display 403 is “not displaying” for the predetermined time period K1 from the occurrence of the communication with the server 102 (in FIGS. 12A and 12B, “APN deletion”).

In this manner, in the case where the communication with the server 102 occurs before the predetermined time period K1 elapses from the transition of the display state of the display 403 to “not displaying”, the periodic accessing of the server 102 can be suspended when the display state is “not displaying” continuously for the predetermined time period K1 from the occurrence of the communication. Thereby, a reply e-mail immediately after the communication with the server 102, etc. can be coped with and therefore, any degradation of the usability can be prevented.

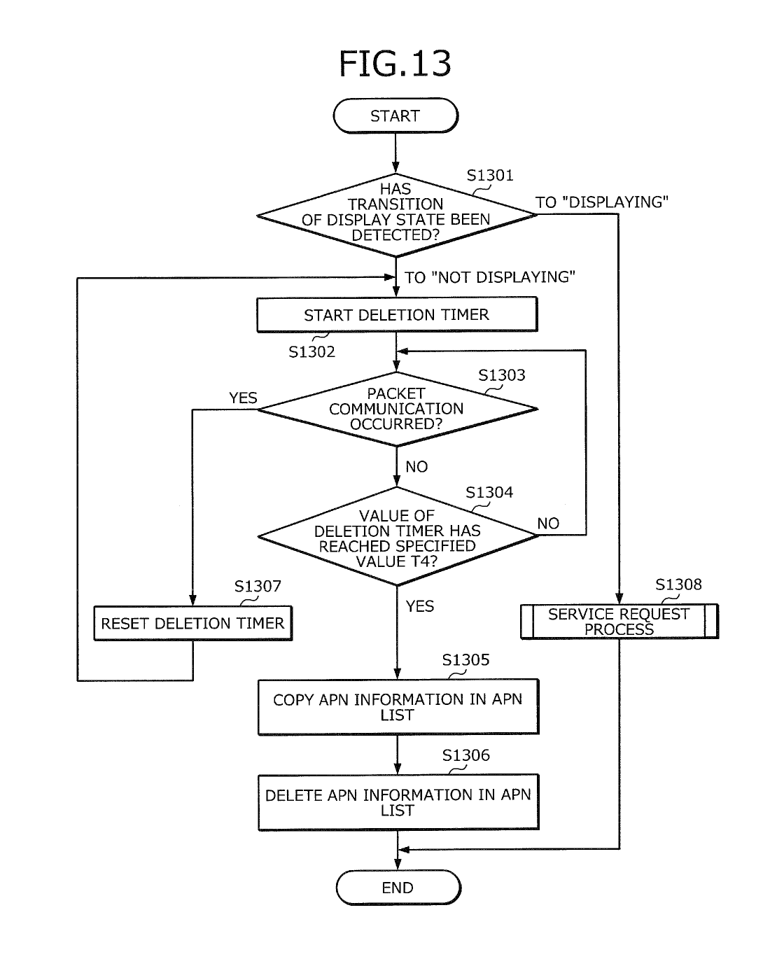

A procedure for the communication process of the communication apparatus 101 according to the second embodiment will be described. FIG. 13 is a flowchart of an example of a procedure for the communication process of the communication apparatus 101 according to the second embodiment. In the flowchart of FIG. 13, the detecting unit 701 determines whether any transition of the display state of the display 403 has been detected (step S1301).

If the detecting unit 701 detects that the display state of the display 403 transitions from “displaying” to “not displaying” (step S1301: TO “NOT DISPLAYING”), the communication control unit 703 starts the deletion timer (step S1302) and determines whether packet communication occurs using the IP address assigned from the server 102 (step S1303).

If the communication control unit 703 determines that no packet communication occurs (step S1303: NO), the communication control unit 703 determines whether the value of the deletion timer has reached the specified value T4 (step S1304). If the communication control unit 703 determines that the value of the deletion timer has not yet reached the specified value T4 (step S1304: NO), the procedure returns to step S1303.

On the other hand, if the communication control unit 703 determines that the value of the deletion timer has reached the specified value T4 (step S1304: YES), the communication control unit 703 copies the APN information in the APN list 600 into the specific storage area of the memory 402 (step S1305), deletes the APN information in the APN list 600 (step S1306), and causes the series of process steps according to the flowchart to come to an end.

If the communication control unit 703 determines at step S1303 that packet communication has occurred (step S1303: YES), the communication control unit 703 resets the deletion timer (step S1307) and the procedure returns to step S1302.

If the detecting unit 701 detects at step S1301 that the display state of the display 403 transitions from “not displaying” to “displaying” (step S1301: TO “DISPLAYING”), the process requesting unit 705 executes a service request process (step S1308) and causes the series of process steps according to the flowchart to come to an end.

Thus, the periodic accessing of the server 102 can be suspended when no communication with the server 102 occurs from the time of the transition of the display state of the display 403 from “displaying” to “not displaying” and the value of the deletion timer reaches the specified value T4.

A specific process procedure will be described for the service request process at step S1308 depicted in FIG. 13.

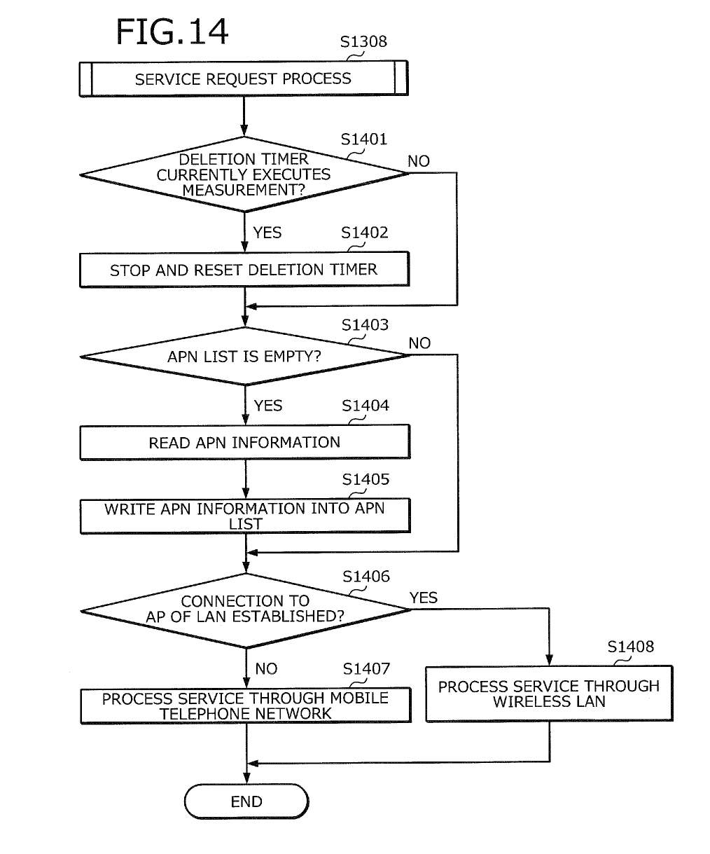

FIG. 14 is a flowchart of an example of a specific process procedure for the service request process. In FIG. 14, the communication control unit 703 determines whether the deletion timer currently executes measurement (step S1401). If the communication control unit 703 determines that the deletion timer is not currently executing the measurement (step S1401: NO), the procedure advances to step S1403.

On the other hand, if the communication control unit 703 determines that the deletion timer is currently executing the measurement (step S1401: YES), the communication control unit 703 stops and resets the deletion timer (step S1402) and determines whether the APN list 600 is empty (step S1403). If the communication control unit 703 determines that the APN list 600 is not empty (step S1403: NO), the procedure advances to step S1406.

On the other hand, if the communication control unit 703 determines that the APN list 600 is empty (step S1403: YES), the communication control unit 703 reads the APN information copied in the specific storage area of the memory 402 (step S1404) and writes the read APN information into the APN list 600 (step S1405).

The process requesting unit 705 determines whether connection is established with the AP 303 of the wireless LAN (step S1406). If the process requesting unit 705 determines that no connection with the AP 303 has been established (step S1406: NO), the process requesting unit 705 processes the service through the mobile telephone network using the public network I/F 406 (step S1407) and causes the series of process steps according to the flowchart to come to an end.

If the process requesting unit 705 determines at step S1406 that the connection with the AP 303 has been established (step S1406: YES), the process requesting unit 705 processes the service through the wireless LAN using the WLAN I/F 407 (step S1408) and causes the series of process steps according to the flowchart to come to an end.

If the IP address assigned to the communication apparatus 101 is released at step S1407, the IP address acquisition process is executed.

Thus, the services that cannot be received during the suspension of the periodic accessing of the server 102 when the display state of the display 403 transitions from “not displaying” to “displaying” can be executed.

As described, according to the communication apparatus 101 of the second embodiment, the periodic accessing of the server 102 can be suspended when the display state of the display 403 transitions from “displaying” to “not displaying” and is “not displaying” continuously for the predetermined time period K1 since the transition. Thus, control can be executed such that the periodic accessing of the server 102 is not suspended when the display state of the display 403 transitions at short time intervals (for example, 15 seconds).

Therefore, any increase of the power consumption of the communication apparatus 101 for the operations to suspend and restart the periodic accessing of the server 102 can be suppressed. Any increase of the communication volume due to the communication with the server 102 can be suppressed when the periodic accessing of the server 102 is restarted. Any degradation of the usability when the display state of the display 403 frequently transitions at short time intervals can be prevented.

According to the communication apparatus 101 of the second embodiment, in a case where communication with the server 102 occurs before the predetermined time period K1 elapses, the periodic accessing of the server 102 can be suspended when the display state of the display 403 is “not displaying” continuously for the predetermined time period K1 since the occurrence of the communication. Thereby, suspension can be prevented of the periodic accessing of the server 102 before a reply e-mail is sent in response to an e-mail received before the predetermined time period K1 elapses, and any degradation of the usability can be prevented.

A communication apparatus 101 according to a third embodiment will be described. In the third embodiment, a case will be described where a predetermined time period that is from the transition of the display state of the display 403 to “not displaying” until the suspension of the periodic accessing of the server 102 (hereinafter, referred to as “APN deletion time period dTa”) is calculated. Parts identical to those described in the first and the second embodiments will be given the same reference numerals used in the first and the second embodiments, and will not again be described.

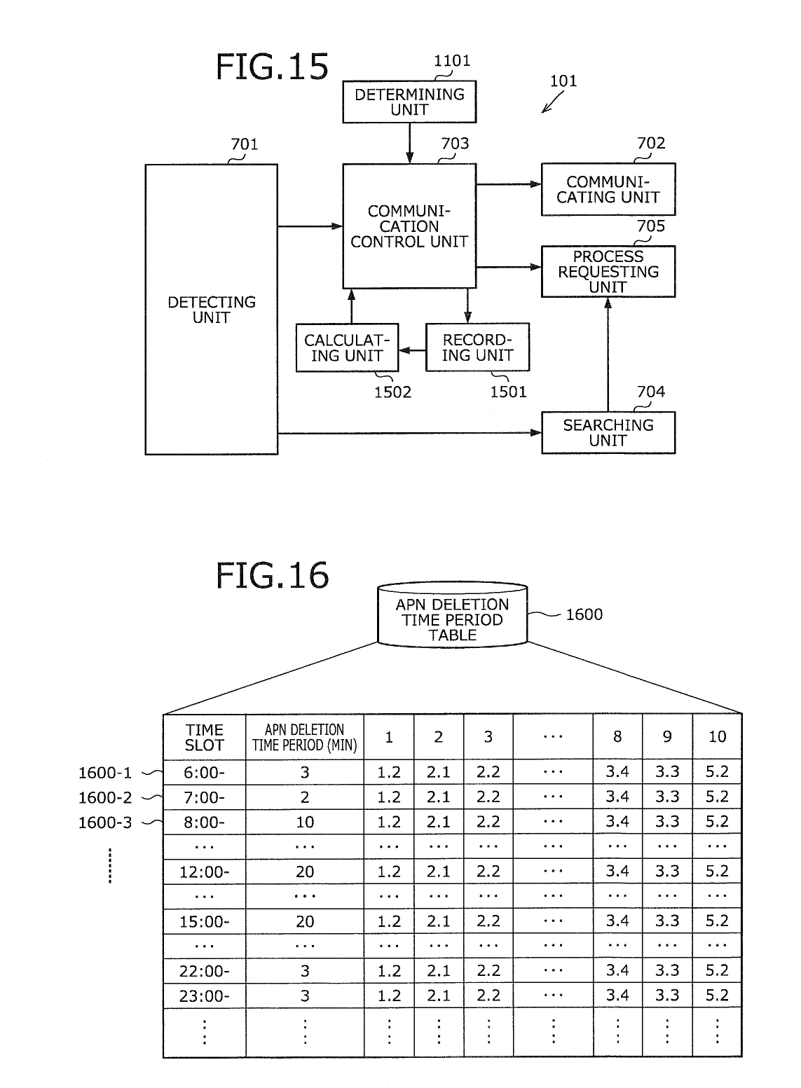

FIG. 15 is a block diagram of an example of a functional configuration of the communication apparatus 101 according to the third embodiment. In FIG. 15, the communication apparatus 101 includes the detecting unit 701, the communicating unit 702, the communication control unit 703, the searching unit 704, the process requesting unit 705, the determining unit 1101, a recording unit 1501, and a calculating unit 1502. The functional units (the units from the detecting unit 701 to the process requesting unit 705, the determining unit 1101, the recording unit 1501, and the calculating unit 1502) forming a control unit, are implemented by, for example, causing the CPU 401 to execute programs stored in the memory 402, or by using the public network I/F 406 and the WLAN I/F 407. The processing result of each of the functional units is, for example, stored to the memory 402.

The communication control unit 703 has a function of suspending the periodic accessing of the server 102 when the display state of the display 403 transitions from “displaying” to “not displaying” and is “not displaying” continuously for the APN deletion time period dTa since the transition. The “APN deletion time period dTa” is identified from, for example, an APN deletion time period table 1600 depicted in FIG. 16 described later.

The communication control unit 703 may suspend the periodic accessing of the server 102 when conditions 1 and 2 are satisfied in a case where communication with the server 102 occurs before the APN deletion time period dTa elapses since the time when the display state of the display 403 transitions from “displaying” to “not displaying”.

The condition 1 prescribes that the APN deletion time period dTa elapses from the time when the display state of the display 403 transitions from “displaying” to “not displaying”. The condition 2 prescribes that the predetermined time period K1 elapses from the time when the communication with the server 102 occurs. However, the conditions 1 and 2 each include a condition that the display state of the display 403 is continuously “not displaying”.

The recording unit 1501 has a function of recording a time interval dTb from a time point tx at which the display state of the display 403 transitions from “displaying” to “not displaying”, until a time point ty at which communication with the server 102 occurs. For example, the recording unit 1501 records therein the time interval dTb from the time point tx until the time point ty at which the last communication session with the server 102 occurs before the periodic accessing of the server 102 is suspended. A “time point” refers to, for example, a date and a time.

The time interval dTb is recorded in, for example, the APN deletion time period table 1600. The APN deletion time period table 1600 is implemented by, for example, the memory 402. The contents of the APN deletion time period table 1600 will be described.

FIG. 16 is an explanatory diagram of an example of the contents of the APN deletion time period table 1600. In FIG. 16, the APN deletion time period table 1600 has fields for the time slot, the APN deletion time period, and the time interval. Setting information in each field causes APN deletion time period information (for example, APN deletion time period information 1600-1 to 1600-3) for the time slots to be stored as records.

The time slot represents a time slot of the day. For example, “6:00” represents a time slot from 6:00 to 6:59. The APN deletion time period represents the time period from the transition of the display state of the display 403 from “displaying” to “not displaying” until the suspension of the periodic accessing of the server 102 (unit: min).

The time interval is the time interval dTb from the time point tx at which the display state of the display 403 transitions from “displaying” to “not displaying”, until the time point ty at which the last communication session with the server 102 occurs before the periodic accessing of the server 102 is suspended (unit: min). In this example, the past 10 time intervals dTb are recorded. The time interval “1” is the newest time interval dTb and the time interval “10” is the oldest time interval dTb.

A case is taken as an example where a time interval “5 min” is recorded at “8:30”. In this case, the recording unit 1501 identifies from the APN deletion time period table 1600, the APN deletion time period information 1600-3 for the time slot for 8:00 and shifts the time intervals set in “1” to “9” of the time interval field for the APN deletion time period information 1600-3 toward the right respectively by one column. A time interval “5.2” set in “10” before the shifting is deleted. The recording unit 1501 records “5.0” in “1” of the time interval field for the APN deletion time period information 1600-3. Thereby, the past 10 time intervals dTb can be recorded for each time slot.

Reference of the description returns to FIG. 15. The calculating unit 1502 has a function of calculating the APN deletion time period dTa based on the recorded time intervals dTb. For example, the calculating unit 1502 may refer to the APN deletion time period table 1600 depicted in FIG. 16 to calculate the average value of the past 10 time intervals dTb as the APN deletion time period dTa.

A case is taken as an example where a time interval “5 min” is recorded at “8:30”. In this case, the calculating unit 1502 identifies from the APN deletion time period table 1600, the APN deletion time period information 1600-3 for the time slot for 8:00, acquires the average value of the time intervals dTb set in “1” to “10” of the time interval field for the APN deletion time period information 1600-3, and thereby, calculates the APN deletion time period dTa. The calculated APN deletion time period dTa is set in the APN deletion time period field of the APN deletion time period information 1600-3.

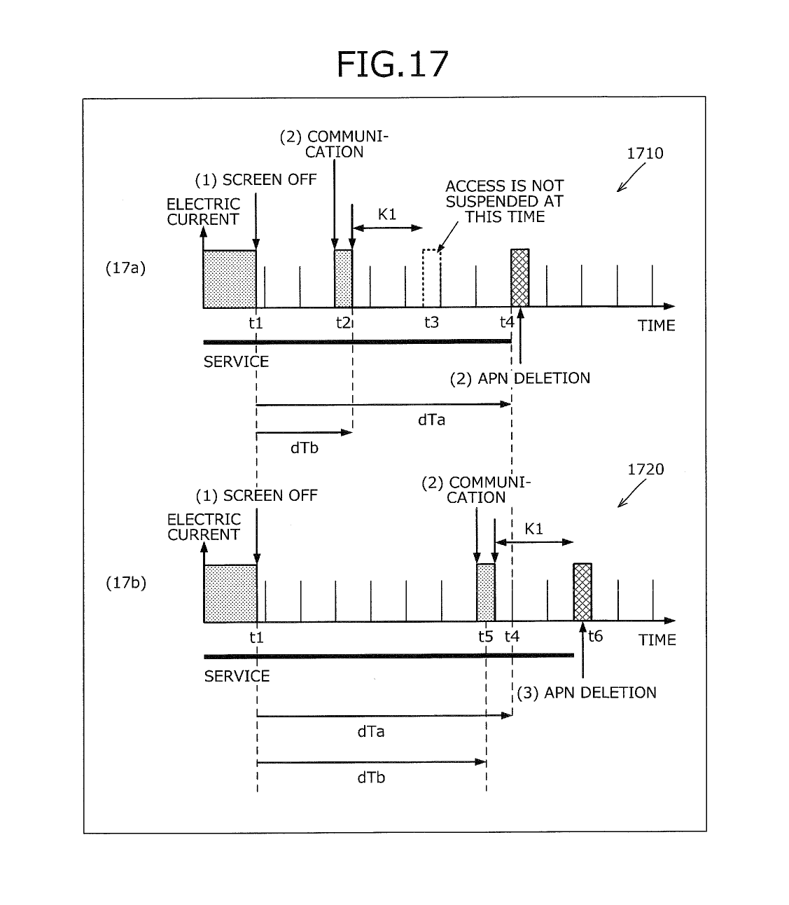

An example of a communication method according to the third embodiment will be described. FIG. 17 is an explanatory diagram of an example of the communication method according to the third embodiment. In FIG. 17, each of graphs 1710 and 1720 presents the power consumption of the communication apparatus 101. The power consumption varies over time. The vertical axis represents the electric current, and the horizontal axis represents time.

In the example of (17a) depicted in FIG. 17, (1) at the time point t1, it is detected that the display state of the display 403 transitions from “displaying” to “not displaying” (in FIG. 17, “screen off”). (2) At the time point t2, the communication with the server 102 occurs before the APN deletion time period dTa elapses since the transition of the display state of the display 403 from “displaying” to “not displaying” (in FIG. 17, “communication occurrence”).

In this case, even when the predetermined time period K1 elapses since the occurrence of the communication with the server 102, the time point t3 at which the predetermined time period K1 elapses is before the time point t4 at which the APN deletion time period dTa elapses since the transition of the display state of the display 403 to “not displaying”. Therefore, the periodic accessing of the server 102 is not suspended at the time period t3.

(3) At the time point t4, the display state of the display 403 transitions to “not displaying” and is “not displaying” continuously for the APN deletion time period dTa from the transition and therefore, the periodic accessing of the server 102 is suspended (in FIG. 17, “APN deletion”).

In the example of (17b) depicted in FIG. 17, (1) at the time point t1, it is detected that the display state of the display 403 transitions from “displaying” to “not displaying” (in FIG. 17, “screen off”). (2) At the time point t5, the communication with the server 102 occurs before the APN deletion time period dTa elapses since the transition of the display state of the display 403 from “displaying” to “not displaying” (in FIG. 17, “communication occurrence”).

In this case, even when the APN deletion time period dTa elapses since the transition of the display state of the display 403 from “displaying” to “not displaying”, the predetermined time period K1 does not yet elapse since the occurrence of the communication with the server 102 and therefore, the periodic accessing of the server 102 is not suspended.

(3) At the time point t6, the display state of the display 403 is “not displaying” continuously for the predetermined time period K1 since the occurrence of the communication with the server 102 and therefore, the periodic accessing of the server 102 is suspended (in FIG. 17, “APN deletion”).

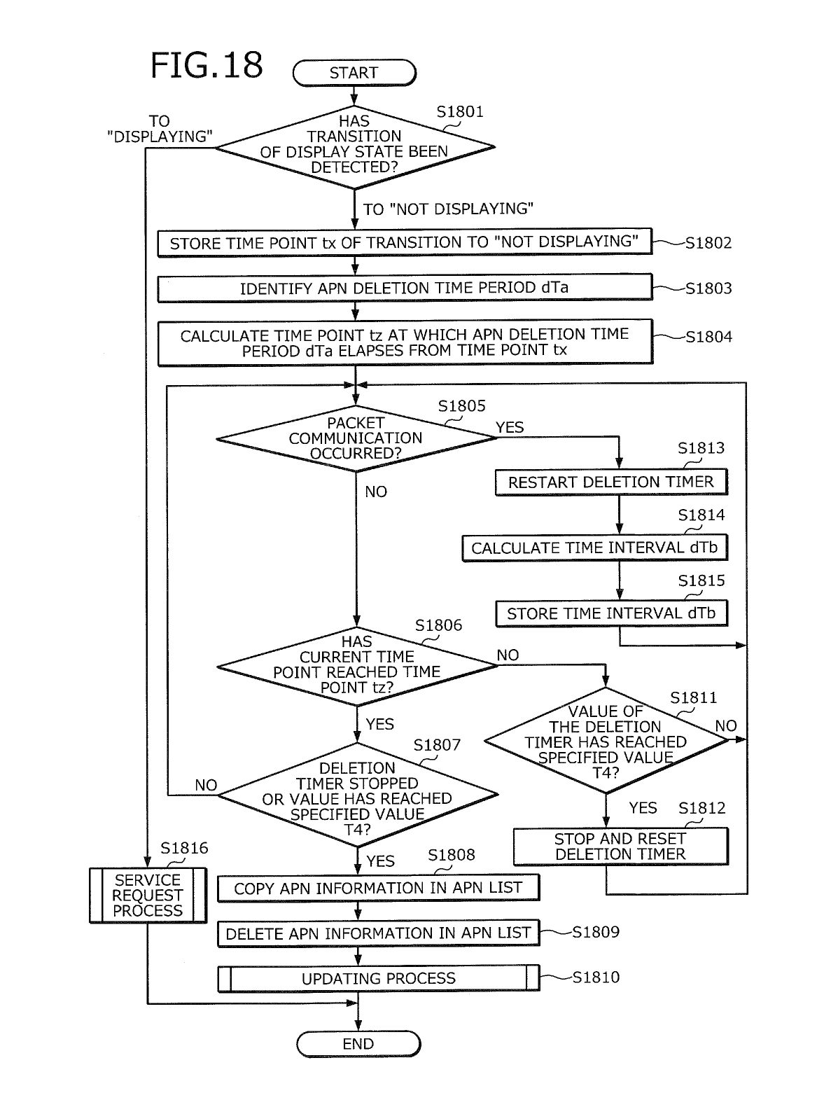

A procedure will be described for a communication process of the communication apparatus 101 according to the third embodiment. FIG. 18 is a flowchart of an example of a procedure for the communication process of the communication apparatus 101 according to the third embodiment. In the flowchart of FIG. 18, the detecting unit 701 determines whether any transition of the display state of the display 403 has been detected (step S1801).

If the detecting unit 701 determines that the transition of the display state of the display 403 from “displaying” to “not displaying” has been detected (step S1801: TO “NOT DISPLAYING”), the communication control unit 703 stores into the memory 402, the time point tx at which the display state of the display 403 transitions from “displaying” to “not displaying” (step S1802).

The communication control unit 703 refers to the APN deletion time period table 1600 and identifies the APN deletion time period dTa of the time slot that includes the time point tx (step S1803) and calculates a time point tz at which the APN deletion time period dTa elapses from the time point tx (step S1804).

The communication control unit 703 determines whether packet communication occurs using the IP address assigned from the server 102 (step S1805). If the communication control unit 703 determines that no packet communication occurs (step S1805: NO), the communication control unit 703 determines whether the current time point has reached the time point tz (step S1806).

If the communication control unit 703 determines that the current time point has reached the time point tz (step S1806: YES), the communication control unit 703 determines whether the deletion timer is stopped or the value thereof has reached the specified value T4 (step S1807). If the communication control unit 703 determines that the deletion timer is currently performing measurement and the value thereof has not yet reached the specified value T4 (step S1807: NO), the procedure returns to step S1805.

On the other hand, if the communication control unit 703 determines that the deletion timer is stopped or the value thereof has reached the specified value T4 (step S1807: YES), the communication control unit 703 copies the APN information in the APN list 600 into the specific storage area of the memory 402 (step S1808).

The communication control unit 703 deletes the APN information in the APN list 600 (step S1809). The calculating unit 1502 executes an updating process to update the APN deletion time period dTa in the APN deletion time period table 1600 (step S1810) and causes the series of process steps according to the flowchart to come to an end.

If the communication control unit 703 determines at step S1806 that the current time point has not yet reached the time point tz (step S1806: NO), the communication control unit 703 determines whether the value of the deletion timer has reached the specified value T4 (step S1811).

If the communication control unit 703 determines that the value of the deletion timer has not yet reached the specified value T4 (step S1811: NO), the procedure returns to step S1805. On the other hand, if the communication control unit 703 determines that the value of the deletion timer has reached the specified value T4 (step S1811: YES), the communication control unit 703 stops and resets the deletion timer (step S1812) and the procedure returns to step S1805.

If the communication control unit 703 determines at step S1805 that packet communication has occurred (step S1805: YES), the communication control unit 703 restarts the deletion timer (step S1813). The recording unit 1501 calculates the time interval dTb from the time point tx at which the display state of the display 403 transitions from “displaying” to “not displaying”, until the time point ty at which the communication with the server 102 occurs (step S1814). The recording unit 1501 stores the calculated time interval dTb into the memory 402 (step S1815) and the procedure returns to step S1805.

If the detecting unit 701 determines at step S1801 that transition of the display state of the display 403 from “not displaying” to “displaying” has been detected (step S1801: TO “DISPLAYING”), the process requesting unit 705 executes the service request process (step S1816) and causes the series of process steps according to the flowchart to come to an end.

The specific process procedure of the service request process at step S1816 is same as that of the service request process at step S1308 depicted in FIG. 14 and therefore, will not again be described.

Thus, control can be executed such that the periodic accessing of the server 102 is not suspended until the time when at least the APN deletion time period dTa elapses since the transition of the display state of the display 403 from “displaying” to “not displaying”. If the communication with the server 102 occurs immediately before the APN deletion time period dTa elapses since the transition of the displaying state of the display 403 to “not displaying”, the time period until the suspension of the periodic accessing of the server 102 can be extended within a range of the predetermined time period K1. The time interval dTb can be recorded that spans from the time point tx at which the display state of the display 403 transitions from “displaying” to “not displaying”, until the time point ty at which the last communication session with the server 102 occurs before the periodic accessing of the server 102 is suspended.

A specific process procedure will be described for the updating process at step S1810 depicted in FIG. 18.

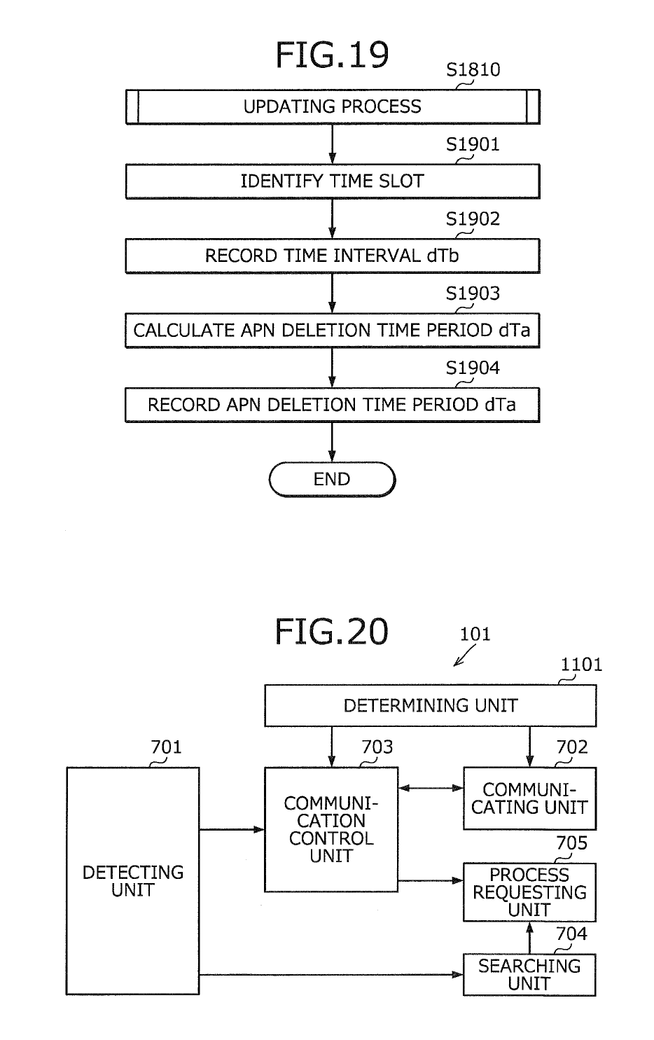

FIG. 19 is a flowchart of an example of a specific process procedure for the updating process. In the flowchart of FIG. 19, the recording unit 1501 identifies the time slot that includes the time point ty at which the last communication session with the server 102 occurred (step S1901).

The recording unit 1501 records the time interval dTb from the time point tx at which the display state of the display 403 transitions from “displaying” to “not displaying” until the time point ty, into the APN deletion time period information of the time slot identified of the APN deletion time period table 1600 (step S1902).

The calculating unit 1502 calculates the APN deletion time period dTa by acquiring the average value of the past 10 time intervals dTb of the APN deletion time period information (step S1903), records the calculated APN deletion time period dTa into the APN deletion time period information (step S1904), and causes the series of process steps according to the flowchart to come to an end.

Thus, based on the past time intervals dTb, the APN deletion time period dTa can be calculated that spans from the time of the transition of the display state of the display 403 from “displaying” to “not displaying”, until the time of the suspension of the periodic accessing of the server 102.

As described, according to the communication apparatus 101 according to the third embodiment, the periodic accessing of the server 102 can be suspended when the display state of the display 403 transitions from “displaying” to “not displaying” and is “not displaying” continuously for the APN deletion time period dTa. In a case where communication with the server 102 occurs before the APN deletion time period dTa elapses, the periodic accessing of the server 102 can be suspended when the APN deletion time period dTa elapses from the transition of the display state to “not displaying” and the display state is “not displaying” continuously for the predetermined time period K1 from the occurrence of the communication.

Thus, control can be executed such that the periodic accessing of the server 102 is not suspended until the time when at least the APN deletion time period dTa elapses since the transition of the display state of the display 403 from “displaying” to “not displaying”. If communication with the server 102 occurs immediately before the APN deletion time period dTa elapses since the transition of the display state of the display 403 to “not displaying”, the time period until the suspension of the periodic accessing of the server 102 can be extended within a range of the predetermined time period K1.

According to the communication apparatus 101 of the third embodiment, the time interval dTb can be recorded that spans from the transition of the display state of the display 403 to “not displaying”, until the occurrence of the last communication session with the server 102 before the suspension of the periodic accessing of the server 102. The APN deletion time period dTa can be calculated based on the plural time intervals dTb accumulated in the APN deletion time period table 1600.

Thus, the APN deletion time period dTa can be calculated that spans from the transition of the display state of the display 403 to “not displaying”, until the suspension of the periodic accessing of the server 102, based on the actual time period from the transition of the display state to “not displaying”, until the occurrence of the last communication session with the server 102.

A communication apparatus 101 according to a fourth embodiment will be described. In the fourth embodiment, a case will be described where a predetermined cycle C (for example, 28 min) to periodically access the server 102 by the always-on function is used as the predetermined time period K1 described in the second embodiment.

In the fourth embodiment, the periodic accessing of the server 102 is suspended when the display state of the display 403 transitions from “displaying” to “not displaying” and is “not displaying” continuously for the predetermined cycle. Parts identical to those described in the first to the third embodiments will be given the same reference numerals used on the first to the third embodiments, and will not again be described.

FIG. 20 is a block diagram of an example of a functional configuration of the communication apparatus 101 according to the fourth embodiment. In FIG. 20, the communication apparatus 101 includes the detecting unit 701, the communicating unit 702, the communication control unit 703, the searching unit 704, the process requesting unit 705, and the determining unit 1101. The functional units (the units from the detecting unit 701 to the process requesting unit 705 and the determining unit 1101) forming a control unit, are implemented by, for example, causing the CPU 401 to execute programs stored in the memory 402, or by using the public network I/F 406 and the WLAN I/F 407. The processing result of each of the functional units is, for example, stored in the memory 402.

The communicating unit 702 has a function of determining whether communication with the server 102 occurs during the predetermined cycle C to periodically access to the server 102. For example, the communicating unit 702 determines whether packet communication with the server 102 occurs, based on the result of the determination by the determining unit 1101. If no communication with the server 102 occurs during the predetermined cycle C, the communicating unit 702 notifies the communication control unit 703 that no communication with the server 102 occurs during the predetermined cycle C.

The communication control unit 703 has a function of suspending the periodic accessing of the server 102 when the display state of the display 403 transitions from “displaying” to “not displaying” and is continuously “not displaying” and no communication with the server 102 occurs during the predetermined cycle C. For example, the communication control unit 703 may suspend the periodic accessing of the server 102 when the communication control unit 703 receives from the communicating unit 702, notification that no communication with the server 102 occurs during the predetermined cycle C.

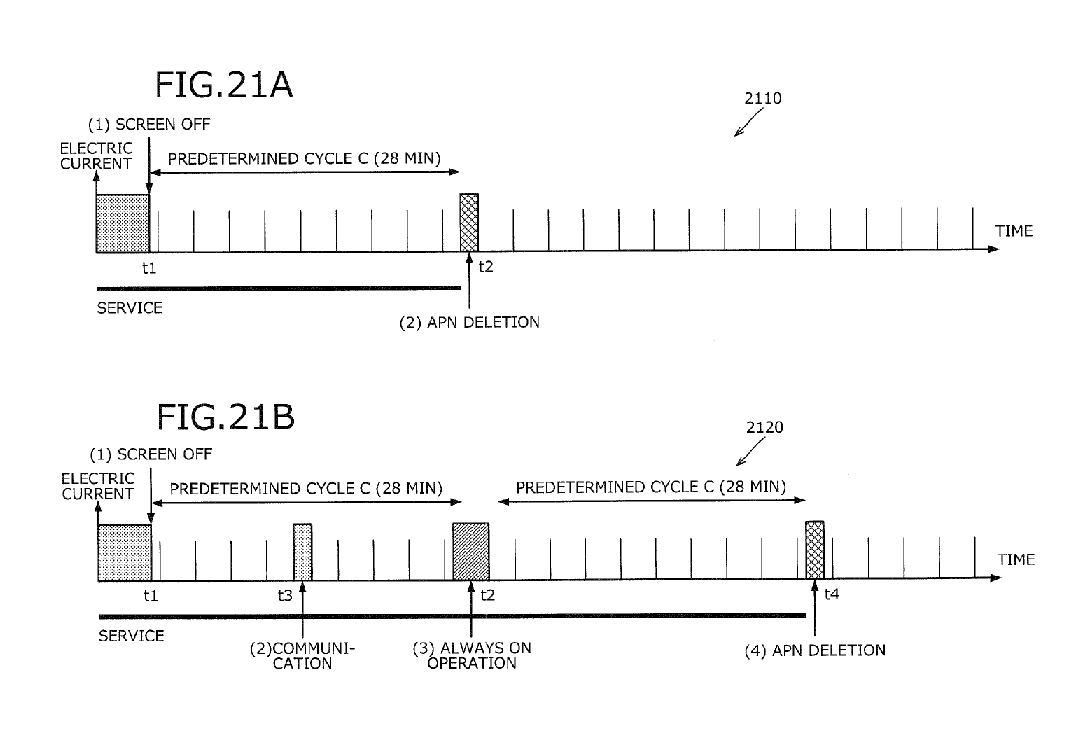

An example of a communication method according to the fourth embodiment will be described. FIGS. 21A and 21B are explanatory diagrams of an example of the communication method according to the fourth embodiment. In FIGS. 21A and 21B, each of graphs 2110 and 2120 presents the power consumption of the communication apparatus 101. The power consumption varies over time. The vertical axis represents the electric current, and the horizontal axis represents time.

In the example depicted in FIG. 21A, (1) at the time point t1, it is detected that the display state of the display 403 transitions from “displaying” to “not displaying” (in FIG. 21A, “screen off”). (2) At the time point t2, the periodic accessing of the server 102 is suspended (in FIG. 21A, “APN deletion”). For example, the display state of the display 403 is “not displaying” continuously for and no communication with the server 102 occurs in the predetermined cycle C from the time point t1 at which the display state of the display 403 transitions to “not displaying” and therefore, the periodic accessing of the server 102 is suspended.

In the example depicted in FIG. 21B, (1) at the time point t1, it is detected that the display state of the display 403 transitions from “displaying” to “not displaying” (in FIG. 21A, “screen off”). (2) At the time point t3, the communication with the server 102 occurs (in FIG. 21B, “communication occurrence”). (3) At the time point t2, the periodic accessing of the server 102 is executed (in FIG. 21B, “always-on operation”). For example, the communication with the server 102 occurs during the predetermined cycle C and therefore, the periodic accessing of the server 102 is not suspended and the normal always-on operation is executed. (4) At the time point t4, the periodic accessing of the server 102 is suspended (in FIG. 21B, “APN deletion”). For example, the display state of the display 403 is continuously “not displaying” and no communication with server 102 occurs during the predetermined cycle C from the time point t2 and therefore, the periodic accessing of the server 102 is suspended.

A procedure for a communication process of the communication apparatus 101 according to the fourth embodiment will be described. A process procedure of a periodic communication process of the communicating unit 702 will be described.

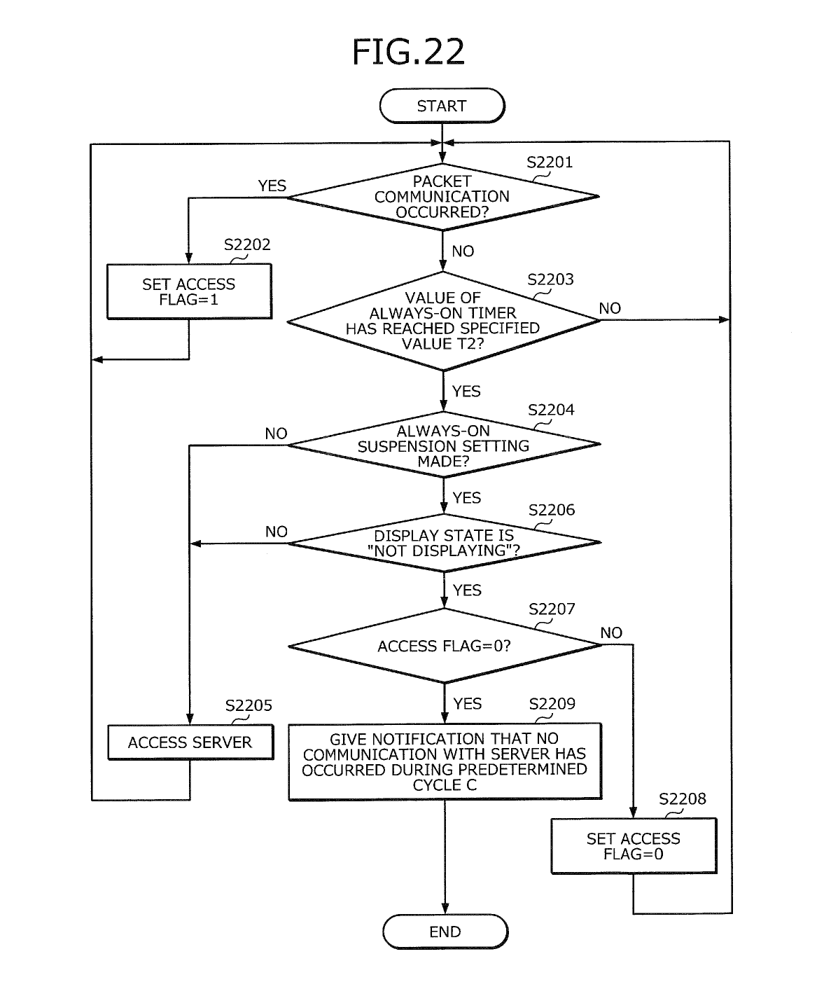

FIG. 22 is a flowchart of an example of a procedure for the periodic communication process of the communication apparatus 101 according to the fourth embodiment. In FIG. 22, the communicating unit 702 determines whether packet communication occurs with the server 102 (step s2201).

If the communicating unit 702 determines that the packet communication has occurred (step S2201: YES), the communicating unit 702 sets an access flag to indicate “1” (step S2202) and the procedure returns to step S2201. The “access flag” is a flag that indicates whether packet communication has occurred with the server 102, and is implemented by, for example, the memory 402.

On the other hand, if the communicating unit 702 determines that no packet communication has occurred (step S2201: NO), the communicating unit 702 determines whether the value of the always-on timer has reached the specified value T2 (step S2203). If the communicating unit 702 determines that the value of the always-on timer has not yet reached the specified value T2 (step S2203: NO), the procedure returns to step S2201.

On the other hand, if the communicating unit 702 determines that the value of the always-on timer has reached the specified value T2 (step S2203: YES), the communicating unit 702 determines whether an always-on suspension setting has been made (step S2204). The “always-on suspension setting” is a setting to suspend the periodic communication with the server 102 and, for example, is set in advance by an operational input by the user via the keypad 404.

If the communicating unit 702 determines that the always-on suspension setting has not been made (step S2204: NO), the communicating unit 702 accesses the server 102 (step S2205) and the procedure returns to step S2201. On the other hand, if the communicating unit 702 determines that the always-on suspension setting is made (step S2204: YES), the communicating unit 702 determines whether the display state of the display 403 is “not displaying” (step S2206).

If the communicating unit 702 determines that the display state of the display 403 is “displaying” (step S2206: NO), the procedure advances to step S2205. On the other hand, if the communicating unit 702 determines that the display state of the display 403 is “not displaying” (step S2206: YES), the communicating unit 702 determines whether the access flag is set to “0” (step S2207).

If the communicating unit 702 determines that the access flag is set to “1” (step S2207: NO), the communicating unit 702 sets the access flag to indicate “0” (step S2208) and the procedure returns to step S2201.

On the other hand, if the communicating unit 702 determines that the access flag is set to “0” (step S2207: YES), the communicating unit 702 notifies the communication control unit 703 that no communication with the server 102 has occurred during the predetermined cycle C (step S2209) and causes the series of process steps according to the flowchart to come to an end.

Thus, when the display state of the display 403 is “not displaying” and no communication with the server 102 occurs during the predetermined cycle C, the communicating unit 702 can notify the communication control unit 703 that no communication with the server 102 has occurred during the predetermined cycle C.

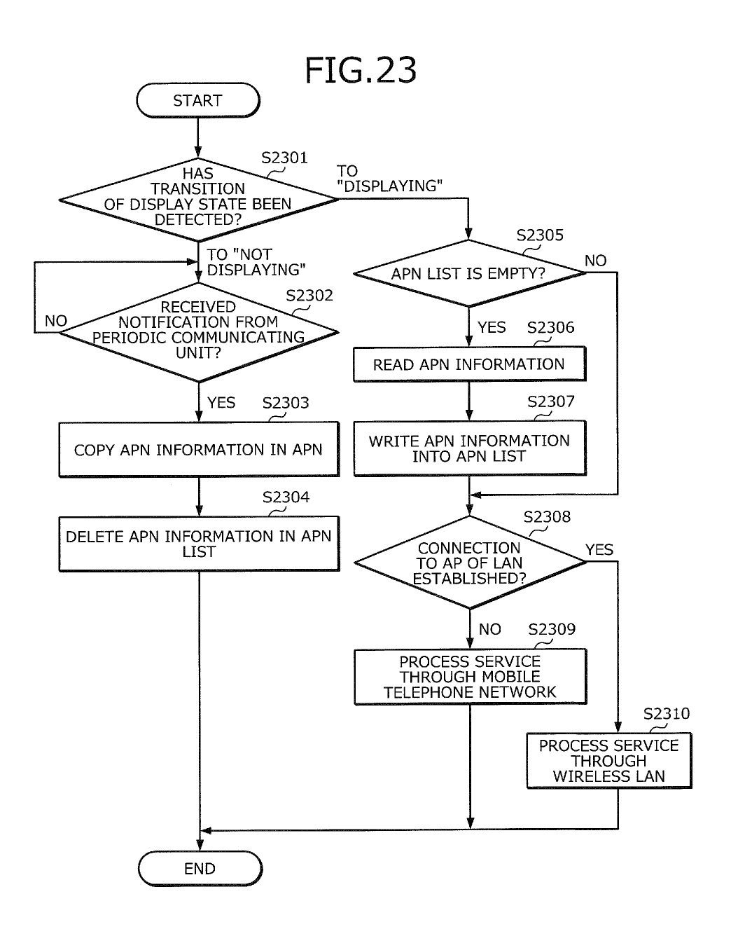

FIG. 23 is a flowchart of an example of a procedure for the communication process of the communication apparatus 101 according to the fourth embodiment. In the flowchart of FIG. 23, the detecting unit 701 determines whether transition of the display state of the display 403 has been detected (step S2301).

If the detecting unit 701 determines that the display state of the display 403 has transitioned from “displaying” to “not displaying” (step S2301: TO “NOT DISPLAYING”), the communication control unit 703 determines whether the communication control unit 703 has received notification from the communicating unit 702 (step S2302). This notification notifies that no communication with the server 102 has occurred during the predetermined cycle C.

The communication control unit 703 waits for notification from the communicating unit 702 (step S2302: NO). When the communication control unit 703 determines that the communication control unit 703 has received notification from the communicating unit 702 (step S2302: YES), the communication control unit 703 copies the APN information in the APN list 600 into the specific storage area of the memory 402 (step S2303). The communication control unit 703 deletes the APN information in the APN list 600 (step S2304) and causes the series of process steps according to the flowchart to come to an end.

If the detecting unit 701 determines at step S2301 that the display state of the display 403 has transitioned from “not displaying” to “displaying” (step S2301: TO “DISPLAYING”), the communication control unit 703 determines whether the APN list 600 is empty (step S2305).

If the communication control unit 703 determines that the APN list 600 is not empty (step S2305: NO), the procedure advances to step S2308. On the other hand, if the communication control unit 703 determines that the APN list 600 is empty (step S2305: YES), the communication control unit 703 reads the APN information copied in the specific storage area of the memory 402 (step S2306) and writes the read APN information into the APN list 600 (step S2307).

The process requesting unit 705 determines whether connection to the AP 303 of the wireless LAN has been established (step S2308). If the process requesting unit 705 determines that no connection to the AP 303 has been established (step S2308: NO), the process requesting unit 705 processes the service through the mobile telephone network using the public network I/F 406 (step S2309) and causes the series of process steps according to the flowchart to come to an end.

If the process requesting unit 705 determines at step S2308 that connection to the AP 303 has been established (step S2308: YES), the process requesting unit 705 processes the service through the wireless LAN using the WLAN I/F 407 (step S2310) and causes the series of process steps according to the flowchart to come to an end.

Thus, the periodic accessing of the server 102 can be suspended when the communication control unit 703 receives notification from the communicating unit 702. If the IP address assigned to the communication apparatus 101 is released at step S2309, the IP address acquisition process is executed.

As described, according to the communication apparatus 101 of the fourth embodiment, the periodic accessing of the server 102 can be suspended when the display state of the display 403 transitions from “displaying” to “not displaying” and is continuously “not displaying” and no communication with the server 102 occurs during the predetermined cycle C.

Thus, the supply of the service can be received until the final moment before the IP address assigned from the server 102 is released. If communication with the server 102 occurs during the predetermined cycle C, the periodic accessing of the server 102 is not suspended until the next cycle comes and therefore, the time period can be extended during which the supply of the service can be received.

A communication apparatus 101 according to a fifth embodiment will be described. A case will be described in the fifth embodiment where, when the display state of the display 403 transitions from “displaying” to “not displaying”, the predetermined time period K1 varies corresponding to, for example, the immediately previous application. Parts identical to those described in the first to the fourth embodiments will be given the same reference numerals used in the first to the fourth embodiments, and will not again be described.

A by-app APN deletion time period table 2400 used by the communication apparatus 101 will be described. The by-app APN deletion time period table 2400 is stored in, for example, the memory 402.

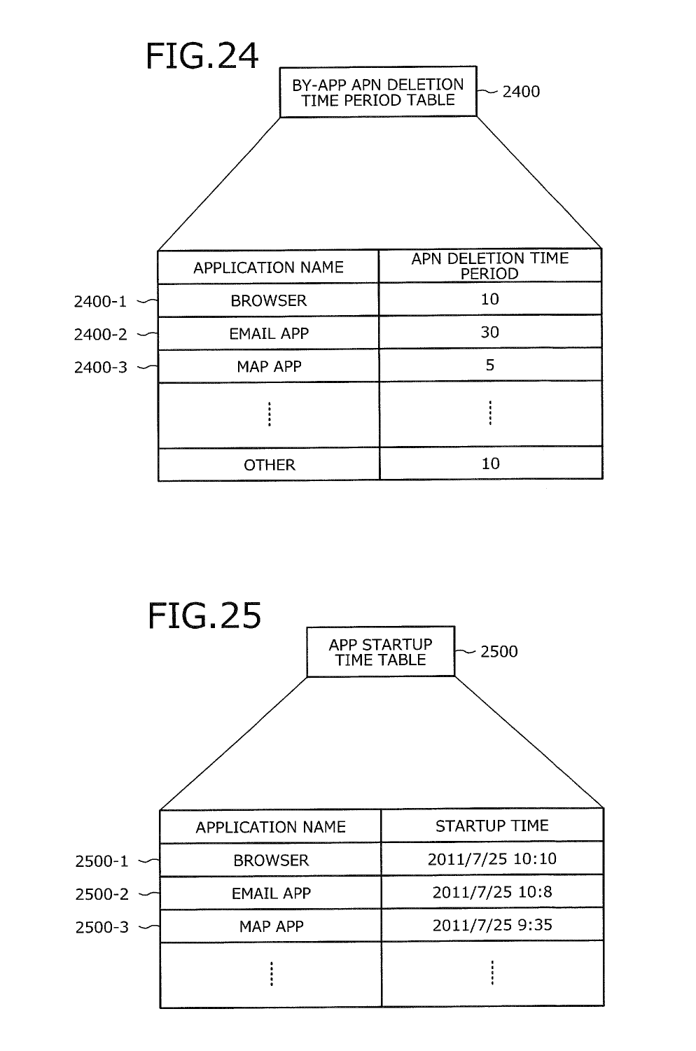

FIG. 24 is an explanatory diagram of an example of the contents of the by-app APN deletion time period table 2400. In FIG. 24, the by-app APN deletion time period table 2400 has fields for the application name and the APN deletion time period. Setting information in each field causes app information (for example, app information 2400-1 to 2400-3) to be stored as records.

The application name is the name of an application. The “application name” used herein represents the type of application. The APN deletion time period is the time period from the transition of the display state of the display 403 to “not displaying”, until the suspension of the periodic accessing of the server 102 (unit: min). The APN deletion time period is the predetermined time period K1 for each application.

Taking an example of the app information 2400-1, the APN deletion time period “10” of the application name “browser” is presented. Taking an example of the app information 2400-2, the APN deletion time period “30” of the application name “e-mail app” is presented.

An app startup time table 2500 used by the communication apparatus 101 will be described. The app startup time table 2500 is stored in, for example, the memory 402.

FIG. 25 is an explanatory diagram of an example of the contents of the app startup time table 2500. In FIG. 25, the app startup time table 2500 has fields for the application name and the startup time. Setting information in each field causes startup time information (for example, startup time information 2500-1 to 2500-3) to be stored as records.

The application name is the name of an application. The startup time is the data and the time on/at which the application is started up by the communication apparatus 101. In the app startup time table 2500, the pieces of startup time information are stored in counter-chronological order of the startup time of the application.

Taking an example of the startup time information 2500-1, the startup time “2011/July/25, 10:10” of the application name “browser” is presented. Taking an example of the startup time information 2500-2, the startup time “2011/July/25, 10:08” of the application name “e-mail app” is presented.

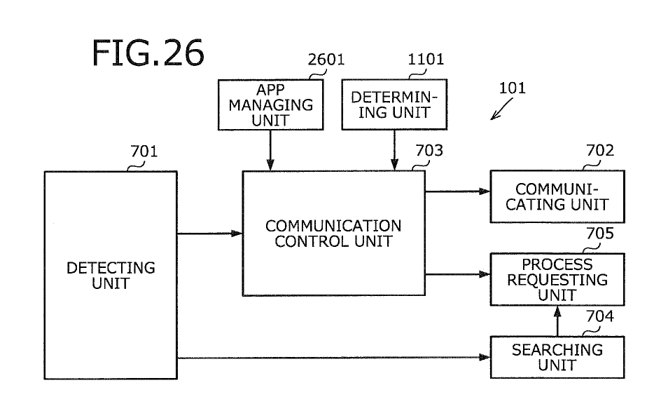

FIG. 26 is a block diagram of an example of a functional configuration of the communication apparatus 101 according to the fifth embodiment. In FIG. 26, the communication apparatus 101 includes the detecting unit 701, the communicating unit 702, the communication control unit 703, the searching unit 704, the process requesting unit 705, the determining unit 1101, and an app managing unit 2601. The functional units (the units from the detecting unit 701 to the process requesting unit 705, the determining unit 1101, and the app managing unit 2601) forming a control unit, are implemented by, for example, causing the CPU 401 to execute the programs stored in the memory 402, or by using the public network I/F 406 and the WLAN I/F 407. The processing result of each of the functional units is, for example, stored in the memory 402.

The app managing unit 2601 has a function of detecting the startup of an application. For example, when the communication apparatus 101 starts up an application, the app managing unit 2601 detects the application name and the startup time of the application. The result of the detection is, for example, stored to the app startup time table 2500 depicted in FIG. 25.

The communication control unit 703 has a function of identifying the predetermined time period K1 that corresponds to the type of application started up before the display state of the display 403 transitions from “displaying” to “not displaying”. For example, the communication control unit 703 refers to the app startup time table 2500 and identifies the application name of the application started up before the display state of the display 403 transitions from “displaying” to “not displaying”.

The application started up before the display state of the display 403 transitions from “displaying” to “not displaying” may, for example, be the application lastly started up before the transition, or may be an application started up during a predetermined time period K2 going back from the time point at which the display state of the display 403 transitions from “displaying” to “not displaying”. The “predetermined time period K2” is stored in, for example, the memory 402 and set in advance (for example, K2=5 min or 10 min).

The communication control unit 703 refers to the by-app APN deletion time period table 2400 depicted in FIG. 24 and identifies the APN deletion time period that corresponds to the identified application name. A case is present where plural application names are identified. In this case, for example, the communication control unit 703 may identify the longest APN deletion time period among the APN deletion time periods that correspond to the identified plural application names.

The communication control unit 703 has a function of suspending the periodic accessing of the server 102 when the display state of the display 403 transitions from “displaying” to “not displaying” and is “not displaying” continuously for the identified predetermined time period K1 since the transition. For example, the communication control unit 703 suspends the periodic accessing of the server 102 when the display state of the display 403 is “not displaying” continuously for the identified APN deletion time period from a time point to at which the display state of the display 403 transitions from “displaying” to “not displaying”.

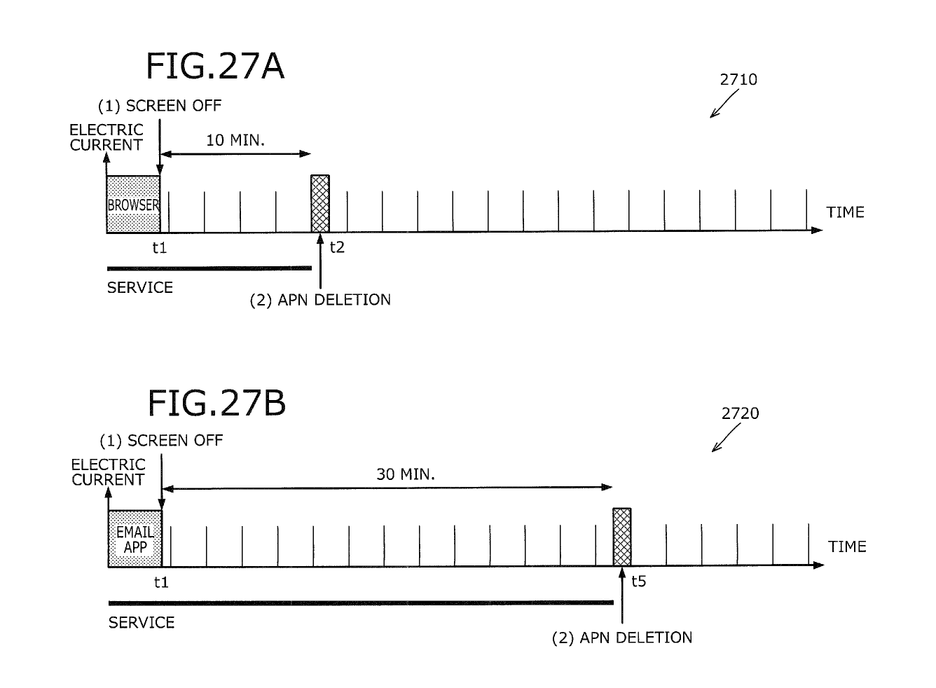

An example of a communication method according to the fifth embodiment will be described. FIGS. 27A and 27B are explanatory diagrams of an example of the communication method according to the fifth embodiment. In FIGS. 27A and 27B, each of graphs 2710 and 2720 presents the power consumption of the communication apparatus 101. The power consumption varies over time. The vertical axis represents the electric current, and the horizontal axis represents time.

In the example depicted in FIG. 27A, (1) at the time point t1, it is detected that the display state of the display 403 transitions from “displaying” to “not displaying” (in FIG. 27A, “screen off”). The application name of the application lastly started up before the time point t1 is “browser” and therefore, “10 min” is set as the APN deletion time period. (2) At the time point t2, the periodic accessing of the server 102 is suspended (in FIG. 27A, “APN deletion”). For example, the display state of the display 403 is “not displaying” continuously for 10 min from the time point t1 at which the display state of the display 403 transitions to “not displaying” and therefore, the periodic accessing of the server 102 is suspended.

In the example depicted in FIG. 27B, (1) at the time point t1, it is detected that the display state of the display 403 transitions from “displaying” to “not displaying” (in FIG. 27B, “screen off”). The application name of the application lastly started up before the time point t1 is “e-mail app” and therefore, “30 min” is set as the APN deletion time period. (2) At the time point t2, the periodic accessing of the server 102 is suspended (in FIG. 27B, “APN deletion”). For example, the display state of the display 403 is “not displaying” continuously for 30 min from the time point t1 at which the display state of the display 403 transitions to “not displaying” and therefore, the periodic accessing of the server 102 is suspended.

A procedure for the communication process of the communication apparatus 101 according to the fifth embodiment will be described. A process procedure for an app management process of the app managing unit 2601 will be described.

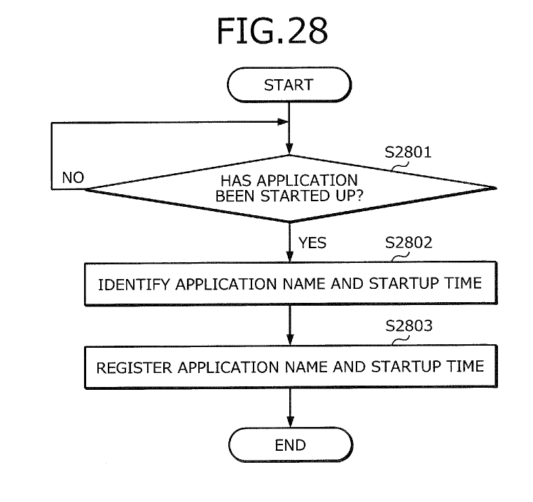

FIG. 28 is a flowchart of an example of a procedure for the app management process of the communication apparatus 101 according to the fifth embodiment. In the flowchart of FIG. 28, the app managing unit 2601 determines whether the communication apparatus 101 has started up an application (step S2801).

The app managing unit 2601 waits for an application to be started up (step S2801: NO). When the app managing unit 2601 determines that the communication apparatus 101 has started up an application (step S2801: YES), the app managing unit 2601 identifies the application name and the startup time of the application (step S2802).

The app managing unit 2601 registers the identified application name and the startup time into the app startup time table 2500 (step S2803) and causes the series of process steps according to the flowchart to come to an end.

Thus, the application name and the startup time of the application started up by the communication apparatus 101 can be registered into the app startup time table 2500.

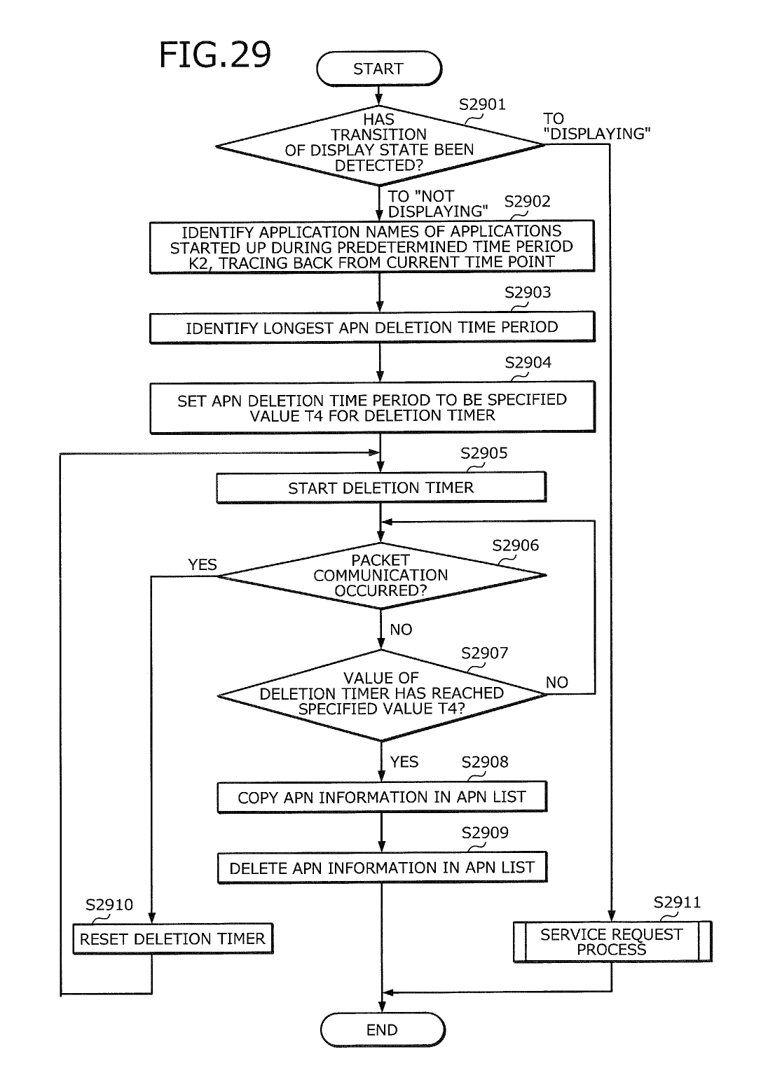

FIG. 29 is a flowchart of an example of a procedure for the communication process of the communication apparatus 101 according to the fifth embodiment. In the flowchart of FIG. 29, the detecting unit 701 determines whether transition of the display state of the display 403 has been detected (step S2901).

If the detecting unit 701 determines that transition of the display state of the display 403 from “displaying” to “not displaying” has been detected (step S2901: TO “NOT DISPLAYING”), the communication control unit 703 refers to the app startup time table 2500 and identifies the application names of the applications started up during the predetermined time period K2 tracing back from the current time point (step S2902).

The communication control unit 703 refers to the by-app APN deletion time period table 2400 and identifies the longest APN deletion time period among the APN deletion time periods that correspond to the identified application names (step S2903) and sets the identified APN deletion time period to be the specified value T4 for the deletion timer (step S2904).

The communication control unit 703 starts the deletion timer (step S2905) and determines whether packet communication occurs with the server 102 (step S2906). If the communication control unit 703 determines that no packet communication has occurred (step S2906: NO), the communication control unit 703 determines whether the value of the deletion timer has reached the specified value T4 (step S2907). If the communication control unit 703 determines that the value of the deletion timer has not yet reached the specified value T4 (step S2907: NO), the procedure returns to step S2906.

On the other hand, if the communication control unit 703 determines that the value of the deletion timer has reached the specified value T4 (step S2907: YES), the communication control unit 703 copies the APN information in the APN list 600 into the specific storage area of the memory 402 (step S2908), deletes the APN information in the APN list 600 (step S2909), and causes the series of process steps according to the flowchart to come to an end.

If the communication control unit 703 determines at step S2906 that the packet communication occurs (step S2906: YES), the communication control unit 703 resets the deletion timer (step S2910) and the procedure returns to step S2905.

If the detecting unit 701 determines at step S2901 that transition of the display state of the display 403 from “not displaying” to “displaying” has been detected (step S2901: TO “DISPLAYING”), the process requesting unit 705 executes the service request process (step S2911) and causes the series of process steps according to the flowchart to come to an end.

The specific process procedure of the service request process at step S2911 is same as that of the service request process at step S1308 depicted in FIG. 14 and therefore, will not again be described.

Thus, the periodic accessing of the server 102 can be suspended when no communication with the server 102 occurs from the time of the transition of the display state of the display 403 from “displaying” to “not displaying” and the value of the deletion timer reaches the specified value T4 corresponding to the type of application immediately previously started up.

As described, according to the communication apparatus 101 of the fifth embodiment, the predetermined time period K1 can be identified that corresponds to the type of application started up before the display state of the display 403 transitions from “displaying” to “not displaying”. The periodic accessing of the server 102 can be suspended when the display state of the display 403 transitions from “displaying” to “not displaying” and is “not displaying” continuously for the identified predetermined time period K1 from the transition.

Thus, the timing at which the periodic accessing of the server 102 is suspended can be varied corresponding to the type of application started up before the transition of the display state of the display 403 from “displaying” to “not displaying”. For example, when the application immediately previously started up is an application for communication such as the e-mail app, after an e-mail is transmitted, a reply e-mail may be sent in response thereto from the communication counterpart. Therefore, the time period until the suspension of the periodic accessing of the server 102 is set to be somewhat long (for example, 30 min) such that an e-mail can be received after the transition of the display state of the display 403 from “displaying” to “not displaying”.

A communication apparatus 101 according to a sixth embodiment will be described. It is assumed that the display state of the display 403 does not transition from “not displaying” to “displaying” continuously for a long time when the battery (not depicted) of the communication apparatus 101 is being recharged or during the night. If the battery of the communication apparatus 101 is currently being charged, it become less necessary to take into consideration the power consumption of the communication apparatus 101 compared to a case where the battery is not currently being charged.

In the sixth embodiment, when the battery of the communication apparatus 101 is currently being charged or during the night, control is executed such that the periodic accessing of the server 102 is not suspended. Parts identical to those described in the first to the fifth embodiments will be given the same reference numerals used in the first to the fifth embodiments, and will not again be described.

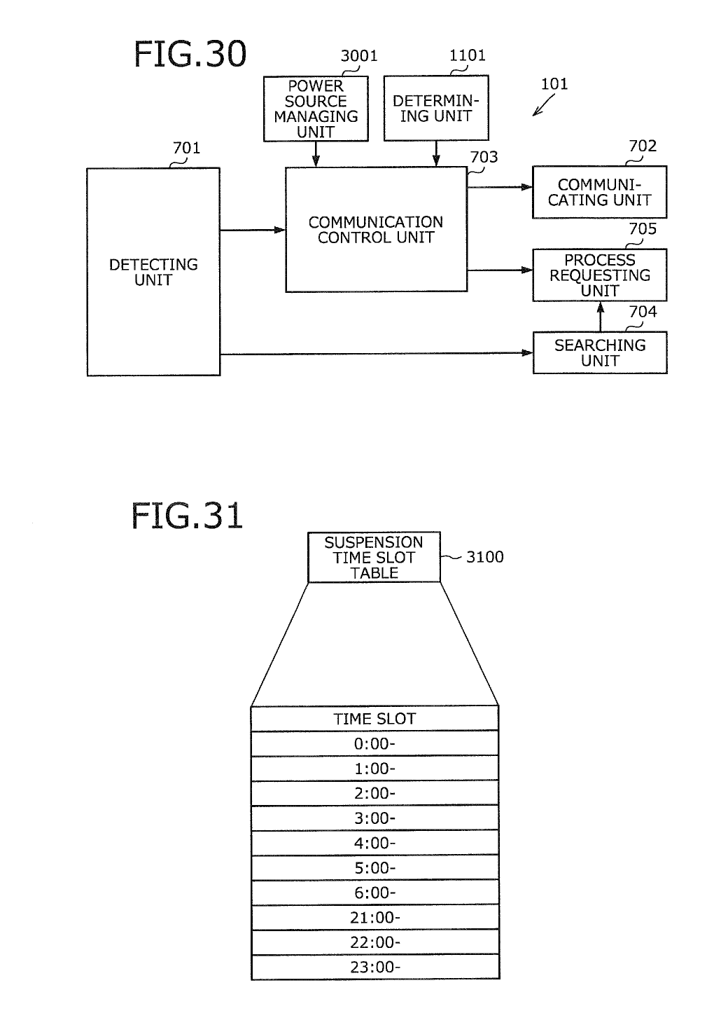

FIG. 30 is a block diagram of an example of a functional configuration of the communication apparatus 101 according to the sixth embodiment. In FIG. 30, the communication apparatus 101 includes the detecting unit 701, the communicating unit 702, the communication control unit 703, the searching unit 704, the process requesting unit 705, the determining unit 1101, and a power source managing unit 3001. The functional units (the units from the detecting unit 701 to the process requesting unit 705, the determining unit 1101, and the poser source managing unit 3001) forming a control unit, are implemented by, for example, causing the CPU 401 to execute programs stored in the memory 402, or by using the public network I/F 406 and the WLAN I/F 407. The processing result of each of the functional units is, for example, stored into the memory 402.

The power source managing unit 3001 has a function of determining whether the battery (not depicted) of the communication apparatus 101 is currently being charged. For example, the power source managing unit 3001 acquires information that indicates whether the battery of the communication apparatus 101 is currently being charged and that is managed by the OS of the communication apparatus 101 and thereby, determines whether the battery is currently being charged.

Thus, it can be determined whether the battery of the communication apparatus 101 is currently being charged or whether the state of the battery of the communication apparatus 101 transitions to a charged state.

The communication control unit 703 has a function of suspending the periodic accessing of the server 102 by controlling the communicating unit 702 when the display state of the display 403 transitions from “displaying” to “not displaying” and the battery of the communication apparatus 101 is not currently being charged. Thus, when the battery of the communication apparatus 101 is currently being charged, control can be executed such that the periodic accessing of the server 102 is not suspended.

The communication control unit 703 has a function of restarting the periodic accessing of the server 102 by controlling the communicating unit 702 when a condition 3 or 4 is satisfied. The “condition 3” prescribes that the display state of the display 403 transitions from “not displaying” to “displaying”. The “condition 4” prescribes that the state of the battery of the communication apparatus 101 transitions to the charged state when the display state of the display 403 is “not displaying”.

Thus, in a case where the periodic accessing of the server 102 is suspended, when the state of the battery of the communication apparatus 101 transitions to the charged state, the periodic accessing of the server 102 can be restarted.

The communication control unit 703 has a function of suspending the periodic accessing of the server 102 by controlling the communicating unit 702 when the display state of the display 403 transitions from “displaying” to “not displaying” and the time point of the transition to “not displaying” is included in a specific time slot. The “specific time slot” is a time slot during which the suspension of the periodic accessing of the server 102 is permitted.

For example, the specific time slot is a time slot during which the display state of the display 403 is less likely not to transition from “not displaying” to “displaying” continuously for a long time, such as a time slot during the daytime; and may be a time slot during which the battery of the communication apparatus 101 is highly likely to not be subject to recharging.

For example, the communication control unit 703 may refer to a suspension time slot table 3100 depicted in FIG. 31 and may identify the time slot during which suspension of the periodic accessing of the server 102 is prohibited. The suspension time slot table 3100 will be described. The suspension time slot table 3100 is stored in, for example, the memory 402.

FIG. 31 is an explanatory diagram of an example of the contents of the suspension time slot table 3100. In FIG. 31, the suspension time slot table 3100 stores time slots during which suspension of the periodic accessing of the server 102 is prohibited. In the example depicted in FIG. 31, the suspension of the periodic accessing of the server 102 is prohibited in the time slots for zero o'clock, one o'clock, two o'clock, three o'clock, four o'clock, five o'clock, six o'clock, 21 o'clock, 22 o'clock, and 23 o'clock.

For example, the communication control unit 703 refers to the suspension time slot table 3100 and determines whether a time slot during which the suspension of the periodic accessing of the server 102 is prohibited includes the time point at which the display state of the display 403 transitions from “displaying” to “not displaying”. If the communication control unit 703 determines that a time slot during which the suspension of the periodic accessing of the server 102 is prohibited includes the time point, the communication control unit 703 performs control such that the periodic accessing of the server 102 is not suspended.

On the other hand, if the communication control unit 703 determines that a time slot during which the suspension of the periodic accessing of the server 102 is prohibited does not include the time point, the communication control unit 703 performs control such that the periodic accessing of the server 102 is suspended. For example, the communication control unit 703 may suspend the periodic accessing of the server 102 if the display state of the display 403 transitions from “displaying” to “not displaying” and is “not displaying” continuously for the predetermined time period K1 from the transition.

A procedure for a communication process of the communication apparatus 101 according to the sixth embodiment will be described.

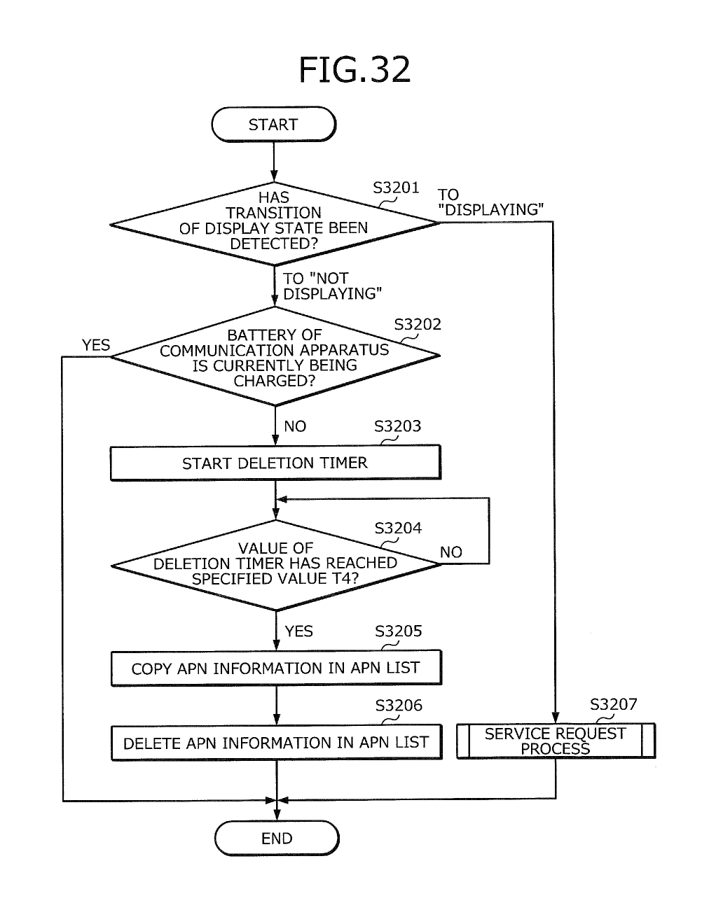

FIG. 32 is a flowchart (Part I) of an example of a procedure for the communication process of the communication apparatus 101 according to the sixth embodiment. In the flowchart depicted in FIG. 32, the detecting unit 701 determines whether transition of the display state of the display 403 has been detected (step S3201).

If the detecting unit 701 determines that transition of the display state of the display 403 from “displaying” to “not displaying” has been detected (step S3201: TO “NOT DISPLAYING”), the power source managing unit 3001 determines whether the battery of the communication apparatus 101 is currently being charged (step S3202).

If the power source managing unit 3001 determines that the battery of the communication apparatus 101 is currently being charged (step S3202: YES), the power source managing unit 3001 causes the series of process steps according to the flowchart to come to an end. On the other hand, if the power source managing unit 3001 determines that the battery of the communication apparatus 101 is not currently being charged (step S3202: NO), the communication control unit 703 starts the deletion timer (step S3203).

The communication control unit 703 determines whether the value of the deletion timer has reached the specified value T4 (step S3204). The communication control unit 703 waits for the value of the deletion timer to reach the specified value T4 (step S3204: NO).

When the communication control unit 703 determines that the value of the deletion timer has reached the specified value T4 (step S3204: YES), the communication control unit 703 copies the APN information in the APN list 600 into the specific storage area of the memory 402 (step 3205), deletes the APN information in the APN list 600 (step S3206), and causes the series of process steps according to the flowchart to come to an end.

If the detecting unit 701 determines at step S3201 that transition of the display state of the display 403 from “not displaying” to “displaying” has been detected (step S3201: TO “DISPLAYING”), the process requesting unit 705 executes the service request process (step S3207) and causes the series of process steps according to the flowchart to come to an end.

The specific process procedure of the service request process at step S3207 is same as that of the service request process at step S1308 depicted in FIG. 14 and therefore, will not again be described.

Thus, control can be executed such that the periodic accessing of the server 102 is not suspended when the battery of the communication apparatus 101 is currently being charged.

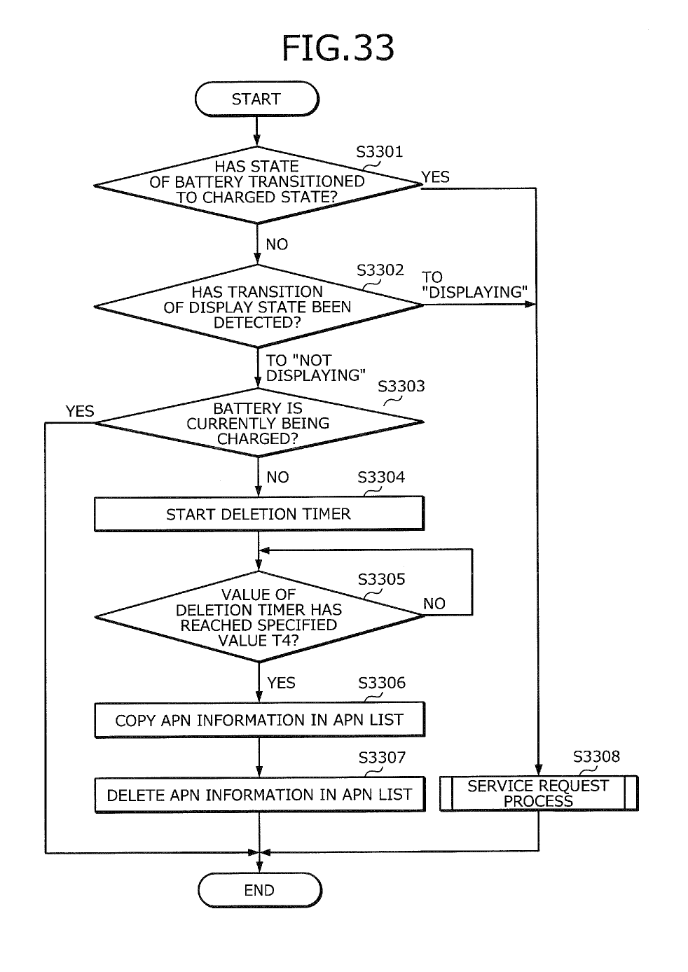

FIG. 33 is a flowchart (Part II) of the example of the procedure for the communication process of the communication apparatus 101 according to the sixth embodiment. In the flowchart depicted in FIG. 33, the power source managing unit 3001 determines whether the state of the battery of the communication apparatus 101 transitions to the charged state when the display state of the display 403 is “not displaying” (step S3301).

If the power source managing unit 3001 determines that the state of the battery does not transition to the charged state (step S3301: NO), the detecting unit 701 determines whether transition of the display state of the display 403 has been detected (step S3302). If the detecting unit 701 determines that the display state of the display 403 has transitioned from “displaying” to “not displaying” (step S3302: TO “NOT DISPLAYING”), the power source managing unit 3001 determines whether the battery of the communication apparatus 101 is currently being charged (step S3303).

If the power source managing unit 3001 determines that the battery of the communication apparatus 101 is currently being charged (step S3303: YES), the power source managing unit 3001 causes the series of process steps according to the flowchart to come to an end. On the other hand, if the power source managing unit 3001 determines that the battery of the communication apparatus 101 is not currently being charged (step S3303: NO), the communication control unit 703 starts the deletion timer (step S3304).

The communication control unit 703 determines whether the value of the deletion timer has reached the specified value T4 (step S3305). The communication control unit 703 waits for the value of the deletion timer to reach the specified value T4 (step S3305: NO).

When the communication control unit 703 determines that the value of the deletion timer has reached the specified value T4 (step S3305: YES), the communication control unit 703 copies the APN information in the APN list 600 into the specific storage area of the memory 402 (step 3306), deletes the APN information in the APN list 600 (step S3307), and causes the series of process steps according to the flowchart to come to an end.

If the power source managing unit 3001 determines at step S3301 that the state of the battery transitions to the charged state (step S3301: YES), the process requesting unit 705 executes the service request process (step S3308) and causes the series of process steps according to the flowchart to come to an end.

If the detecting unit 701 determines at step S3302 that transition of the display state of the display 403 from “not displaying” to “displaying” has been detected (step S3302: TO “DISPLAYING”), the process requesting unit 705 executes the service request process (step S3308) and causes the series of process steps according to the flowchart to come to an end.

The specific process procedure of the service request process at step S3308 is same as that of the service request process at step S1308 depicted in FIG. 14 and therefore, will not again be described.

Thus, the periodic accessing of the server 102 can be restarted when the state of the battery of the communication apparatus 101 transitions to the charged state in a case where the periodic accessing of the server 102 is suspended. Control can be executed such that the periodic accessing of the server 102 is not suspended when the battery of the communication apparatus 101 is currently being charged.

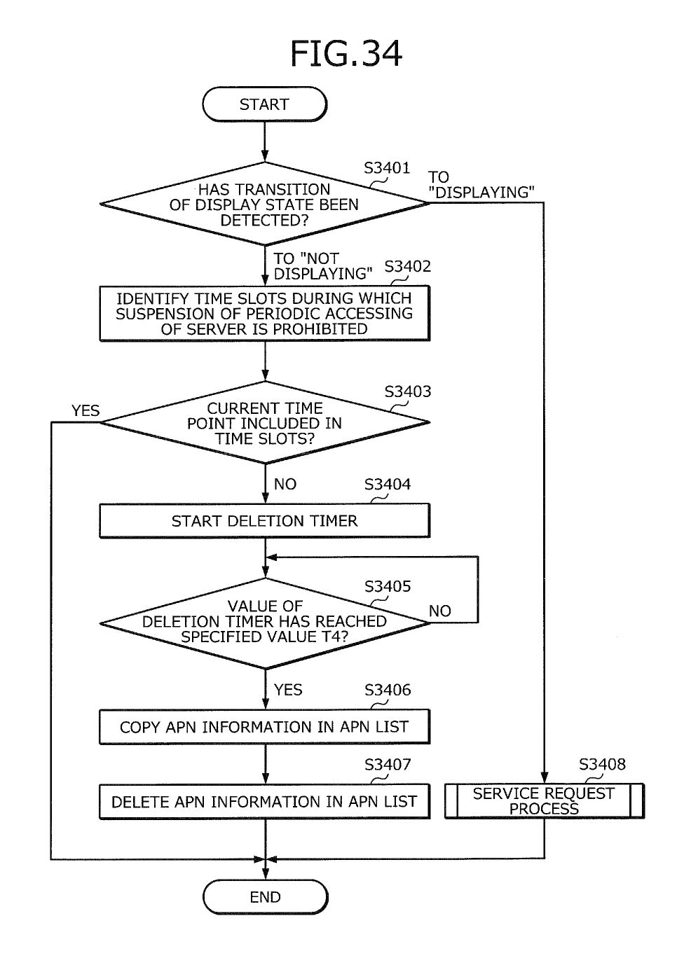

FIG. 34 is a flowchart (Part III) of the example of the procedure for the communication process of the communication apparatus 101 according to the sixth embodiment. In the flowchart depicted in FIG. 34, the detecting unit 701 determines whether transition of the display state of the display 403 has been detected (step S3401).

If the detecting unit 701 determines that the display state of the display 403 transitions from “displaying” to “not displaying” (step S3401: TO “NOT DISPLAYING”), the communication control unit 703 refers to the suspension time slot table 3100 and identifies the time slots during which the suspension of the periodic accessing of the server 102 is prohibited (step S3402).

The communication control unit 703 determines whether the current time point is included in the identified time slots (step S3403). If the communication control unit 703 determines that the current time point is included in the identified time slots (step S3403: YES), the communication control unit 703 causes the series of process steps according to the flowchart to come to an end.

On the other hand, if the communication control unit 703 determines that the current time point is not included in the identified time slots (step S3403: NO), the communication control unit 703 starts the deletion timer (step S3404). The communication control unit 703 determines whether the value of the deletion timer has reached the specified value T4 (step S3405). The communication control unit 703 waits for the value of the deletion timer to reach the specified value T4 (step S3405: NO).

When the communication control unit 703 determines that the value of the deletion timer has reached the specified value T4 (step S3405: YES), the communication control unit 703 copies the APN information in the APN list 600 into the specific storage area of the memory 402 (step 3406), deletes the APN information in the APN list 600 (step S3407), and causes the series of process steps according to the flowchart to come to an end.

If the detecting unit 701 determines at step S3401 that transition of the display state of the display 403 from “not displaying” to “displaying” has been detected (step S3401: TO “DISPLAYING”), the process requesting unit 705 executes the service request process (step S3408) and causes the series of process steps according to the flowchart to come to an end.

The specific process procedure of the service request process at step S3408 is same as that of the service request process at step S1308 depicted in FIG. 14 and therefore, will not again be described.

Thus, control can be executed such that the periodic accessing of the server 102 is not suspended in a time slot during which the display state of the display 403 is highly likely not to transition from “not displaying” to “displaying” continuously for a long time or a time slot during which the battery not depicted of the communication apparatus 101 is highly likely to be subject to recharging, such as late at night or early in the morning.

As described, according to the communication apparatus 101 of the sixth embodiment, the periodic accessing of the server 102 can be suspended if it is determined that the display state of the display 403 transitions from “displaying” to “not displaying” and the battery is not currently being charged. Thus, control can be executed such that the periodic accessing of the server 102 is not suspended when the battery of the communication apparatus 101 is currently being charged.

According to the communication apparatus 101 of the sixth embodiment, the periodic accessing of the server 102 can be restarted if the display state of the display 403 transitions to “displaying” or if the display state is “not displaying” and the state of the battery transitions to the charged state. Thus, the periodic accessing of the server 102 can be restarted when the state of the battery of the communication apparatus 101 transitions to the charged state in a case where the periodic accessing of the server 102 is suspended.

According to the communication apparatus 101 of the sixth embodiment, the periodic accessing of the server 102 can be suspended if the display state of the display 403 transitions to “not displaying” and the specific time slot includes the time point at which the display state transitions to “not displaying”. Thus, control can be executed such that the periodic accessing of the server 102 is not suspended in a time slot during which the display state of the display 403 is highly likely not to transition from “not displaying” to “displaying” continuously for a long time or a time slot during which the battery is highly likely to be subject to recharging, such as late at night or early in the morning.

The embodiments above can be implemented in combination within a non-conflicting range. The communication method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication apparatus comprising:
a processor configured to:
access a server that assigns to the communication apparatus, identification information used to identify the communication apparatus in a network; and
control to suspend an accessing of the server when a display state of a screen transitions from a displaying state to a not-displaying state, such that the accessing of the server is restarted when the display state of the screen transitions from the not-displaying state to the displaying state.

2. The communication apparatus according to claim 1, wherein
the processor is further configured to transmit to the server when the accessing of the server is restarted, a process request for a service supplied by the server.

3. The communication apparatus according to claim 2, wherein
the processor suspends the accessing of the server when the display state of the screen is the not-displaying state continuously for a predetermined time period after the display state of the screen transitions from the displaying state to the not-displaying state.

4. The communication apparatus according to claim 3, wherein
the processor suspends the accessing of the server, when communication with the server occurs before the predetermined time period elapses from a time when the display state of the screen transitions from the displaying state to the not-displaying state and the display state of the screen is the not-displaying state continuously for the predetermined time period from a time when the communication with the server occurs.

5. The communication apparatus according to claim 4, wherein
the processor suspends the accessing of the server, when the communication with the server occurs before a first predetermined time period elapses from the time when the display state of the screen transitions from the displaying state to the not-displaying state and after the time when the display state of the screen transitions from the displaying state to the not-displaying state, the first predetermined time period elapses and the display state of the screen is the not-displaying state continuously for a second predetermined time period that is from the time when the communication with the server occurs.

6. The communication apparatus according to claim 5, wherein the processor is further configured to:
record a time interval from the time when the display state of the screen transitions from the displaying state to the not-displaying state until the time when the communication with the server occurs, when the communication with the server occurs before the first predetermined time period elapses from the time when the display state of the screen transitions from the displaying state to the not-displaying state; and
calculate the first predetermined time period, based on the recorded time interval.

7. The communication apparatus according to claim 3, further comprising
a storing unit that stores a predetermined time period for each type of application, the predetermined time period spanning from a time when the display state of the screen transitions from the displaying state to the not-displaying state to a time when the accessing of the server is suspended, wherein
the processor is further configured to identify based on contents stored by the storing unit, the predetermined time period corresponding to the type of application started up before the time when the display state of the screen transitions from the displaying state to the not-displaying state, and
the processor suspends the accessing of the server when the display state of the screen is the not-displaying state continuously for the identified predetermined time period from the time when the display state of the screen transitions from the displaying state to the not-displaying state.

8. The communication apparatus according to claim 7, wherein
the processor identifies based on the contents of the storing unit, the predetermined time period that is longest among predetermined time periods corresponding to types of applications started up within the predetermined time period, tracing backward from the time when the display state of the screen transitions from the displaying state to the not-displaying state.

9. The communication apparatus according to claim 3, wherein
the processor accesses the server at predetermined cycles, and
the processor suspends the accessing of the server when no communication with the server occurs during the predetermined cycle.

10. The communication apparatus according to claim 2, wherein the processor is further configured to
determine whether a battery of the communication apparatus is currently being charged, and
the processor, upon determining that the battery is not currently being charged and when the display state of the screen transitions from the displaying state to the not-displaying state, controls to suspend the accessing of the server.

11. The communication apparatus according to claim 10, wherein
the processor controls to restart the accessing of the server, when the display state of the screen transitions from the not-displaying state to the displaying state, or when the display state of the screen is the not-displaying state and a state of the battery transitions to a charged state.

12. The communication apparatus according to claim 2, wherein
the processor controls to suspend the accessing of the server, when the display state of the screen transitions from the displaying state to the not-displaying state and a specific time slot includes a time point at which the display state of the screen transitions from the displaying state to the not-displaying state.

13. The communication apparatus according to claim 2, wherein
the processor transmits the process request for the service to the server, when a given time period elapses from a time when the display state of the screen transitions from the not-displaying state to the displaying state when the accessing of the server has been restarted.

14. A communication method comprising:
controlling a communicating unit that accesses a server that assigns to an apparatus, identification information used to identify the apparatus in a network, and suspending the accessing of the server, when a display state of a screen transitions from a displaying state to a non-display state; and
controlling the communicating unit, and restarting the accessing of the server, when the display state of the screen transitions from the non-displaying state to the displaying state, wherein
the communication method is executed by a computer of the apparatus.

15. A non-transitory, computer-readable recording medium that causes a computer to execute a process comprising:
controlling a communicating unit that accesses a server that assigns to an apparatus of the computer, identification information used to identify the apparatus in a network, and suspending the accessing of the server, when a display state of a screen transitions from a displaying state to a non-display state; and
controlling the communicating unit, and restarting the accessing of the server, when the display state of the screen transitions from the non-displaying state to the displaying state.
